(19) United States
(12) Patent Application Publication
(10) Pub. No.: US 2025/0328535 A1
(43) Pub. Date: Oct. 23, 2025

(54) ENHANCING ARTIFICIAL INTELLIGENCE CHATBOTS WITH SEARCH FUNCTIONALITY

(71) Applicant: MicroStrategy Incorporated, Vienna, VA (US)

(72) Inventors: Gang Liang, Fairfax, VA (US); Sergio Sainz, Vienna, VA (US); Jun Zhu, Potomac, MD (US); Abdul Rahman, Warsaw (PL); Jaime Alberto Perez, Brambleton, VA (US); Ananya Ojha, Dunn Loring, VA (US); Jeffrey Clay Courcelle, Atkinson, NH (US)

(21) Appl. No.: 19/252,151

(22) Filed: Jun. 27, 2025

Related U.S. Application Data
(63) Continuation-in-part of application No. 18/596,738, filed on Mar. 6, 2024.
(60) Provisional application No. 63/665,044, filed on Jun. 27, 2024.

(51) Int. Cl. G06F 16/2457; G06F 16/22; G06N 3/006

(52) U.S. Cl. CPC G06F 16/24575; G06F 16/2228; G06N 3/006

(57) ABSTRACT

Methods, systems, and apparatus, including computer-readable media, for enhancing artificial intelligence chatbots with search functionality. In some implementations, a system stores a search index for data sets, where the search index describes data objects of the data sets and values for the data objects in the data sets. The system receives a user prompt to a chatbot and searches for data objects and values that are relevant to the user prompt, including using the search index to search for data objects and values of one or more data sets that the chatbot is configured to access. The system uses one or more results obtained using the search index to generate a chatbot response to the user prompt, including providing the one or more results to an artificial intelligence and/or machine learning (AI/ML) model. The system provides the chatbot response as a response to the user prompt.

### CROSS-REFERENCE TO RELATED APPLICATIONS

This application is a continuation-in-part (CIP) of U.S. patent application Ser. No. 18/596,738, filed on Mar. 6, 2024, and this application claims the benefit of priority to U.S. Provisional Patent Application No. 63/665,044, filed on Jun. 27, 2024, and the entire contents of both applications are hereby incorporated by reference herein.

### BACKGROUND

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users. Training the most capable models typically requires a very large amount of training data as well as large amounts of computing power and time. Many users use generalized models that are highly trained and highly capable, but are limited to default behavior and cannot be customized for particular uses or contexts.

### SUMMARY

In some implementations, a computer system provides access to artificial intelligence or machine learning (AI/ML) chatbots and enhances the functionality of the chatbots with search capabilities. The system can enhance the accuracy of chatbots by using search functionality to improve the ability of the chatbot to interpret terms in user prompts and obtain information from data sets. For example, when a user prompt to a chatbot is received, the system can use a search index or other search functionality to identify or disambiguate references to attributes, metrics, and other data objects, which will allow an AI/ML model such as a large language model (LLM) to reference the correct data objects in its responses. Those responses can include code or instructions for retrieving data from a data set, so the initial search providing the data object information allows the AI/ML model to more accurately formulate the SQL statements or other requests for the data that is needed to ultimately answer the user prompt.

For example, when the system receives a user prompt, the system can use a search index to determine which data objects (e.g., attributes, metrics, data table columns, etc.) are relevant to the terms in the user prompt. The search index can include information about the data set that the chatbot is able to access. For example, the search index can include information derived from the structure and metadata of a data set, such as the data table names, data table labels, column names, column labels, and other metadata. In addition, the search index can include information derived from the content of the data set, e.g., values in the data set in various columns or other portions. With the information in the search index, the system can quickly and efficiently search for and find (1) data objects in the schema or data model for the data set that are relevant to the terms in the user prompt and (2) instances of values or records that are relevant to the terms in the user prompt. For example, the system can search to find data objects or values that match or are similar to the terms in the user prompt.

From the information identified in the search, the system can generate information that supplements the user prompt in the processing by an AI/ML model. For example, the system can provide, with the user prompt, a list of data objects (e.g., identifiers for metrics, data tables, attributes, columns, etc.) identified to be relevant. As another example, the system can provide information that specifies relationships between terms of the user prompt and data objects, such as indicating the data objects identified as being most closely related to particular words or phrases of the user prompt. As another example, the system can indicate other relationships identified, such as occurrences of a term in the user prompt in specific portions of the data set (e.g., the term “New York” in a user prompt is included in a column called “City” of a data table called “Store Locations” in the data set). This information can provide the AI/ML model the information links or connections needed to properly interpret the user prompt and generate an accurate answer.

As an example, a user prompt may ask, “what are last month's orders in the north?” In this case, the meaning of “last month” may be clear, but “orders” and “north” may be unclear based on the prompt and preceding interactions in the conversation alone. The system can search the index and find that “orders” matches or is similar to a description or name for a particular column of data, named “Order Value,” specifying the currency value of orders placed. The system can also use the search index to search for “north” and may find that the word “north” is included as a value in the “Sales Region” column. As a result, the system can identify the “Sales Region” column as relevant to the phrase “in the north,” and more specifically that the phrase refers to records filtered to the value of “north” in the “Sales Region” column. The system then provides a request for the AI/ML model that includes the user prompt as well as the relevant results found through the search, e.g., information indicating the “Order Value” being relevant to the “order” term and the “Sales Region” column being relevant to the “north” term. The system can provide the results of the search in any of various forms, such as a statement designating data objects identified for specific terms or simply a list of identified results (e.g., data objects with matching labels or descriptions, data objects with values matching terms of the prompt, etc.) for various terms. The AI/ML model can then use the results of the search to interpret the user prompt, so the AI/ML model accurately maps the terms of the user prompt to appropriate data elements of one or more data sets and so accurate data can be retrieved from the one or more data sets to answer the user prompt.

In some implementations, the system also searches for and provides results from one or more knowledge bases that include content such as a dictionary, glossary, synonyms, definitions, or other information for an organization. For example, the system can access a knowledge base that describes a company's abbreviations, acronyms, project names, and so on, and compare the content of the user prompt to the knowledge base content to identify relevant items. The system can provide the identified items from the knowledge base (e.g., items having matches to one or more terms of the user prompt) to the AI/ML model to assist in interpreting the user prompt.

In some implementations, the system uses searching to identify which data set(s), from among multiple data sets, should be used to answer a user prompt. For example, a chatbot may be configured to use data from any of multiple data sets. Even if a relevant data set is not known from context, or is not specified in the user prompt, the search feature can find the data set(s) that include the terms of the query. The system can identify the data sets (and the particular data objects in the data sets) that are relevant using a search index that describes information about the metadata or structure of the data sets (e.g., names, labels, identifiers, descriptions, etc.) and the information about the contents of the data sets (e.g., values in the data sets).

In some implementations, the system uses a vector database to select or retrieve relevant portions of a knowledge base or to identify relevant data objects and data sets. For example, the vector database can store information such as labels or descriptions for data sets and data objects. For example, metadata or content of a data model for a data set can be entered in a vector database and represented with embeddings or positions in a high-dimensional vector space. The system can also represent the user prompt, or separate chunks or portions of the user prompt, in the vector space. The system can then identify the data sets and data objects that that are closest to the terms of the user prompt in the vector space, where the closest data sets and data objects are the most similar to the concepts of the terms in the user prompt. For example, the system can provide an AI/ML model data that indicates, for each of one or more different terms or portions of a user prompt, the data objects that are closest in the vector space. This can include limiting the set of data objects for a prompt term to those that have at least a minimum level of similarity to the prompt term (e.g., no more than a maximum distance from the prompt term in the vector space), limiting the set of data objects to no more than a maximum number (e.g., 3, 5, etc.) of the most similar data objects for a prompt term, and so on. The system can also provide the AI/ML model a score for each data object indicating the similarity (e.g., based on the vector space distance) of the data objects to the applicable prompt term, to provide a basis for ranking the data objects or assessing the confidence or likelihood that the indicated data object relates to the prompt term. Using the same vector database techniques, the system can also identify and provide to an AI/ML model (1) semantic graph content that is relevant to prompt terms and (2) knowledge base content that is relevant to prompt terms. More generally, the vector database techniques can be used to perform similarity searching, or nearest-neighbor searching, or other types of searching based on the comparison or distance of vector embeddings to identify data objects, data set content (e.g., values), knowledge base content, semantic graph content, and more.

Combining the processing of AI/ML systems and non-AI/ML systems in chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata (e.g., a data model or data schema) describing the general type of contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model—and any third-party providing the AI/ML model as a service—access to portions of the dataset that are not appropriate for answering the current question.

The customizations that the administrator set in creating or customizing the chatbot can be used to alter the operation and results of the non-AI/ML data processing system, the AI/ML model, the front-end interface that the user sees, or a combination of any or all of them. For example, the customizations that the administrator selects can specify which dataset(s) to use when answering questions, whether additional public datasets or the Internet can be used to answer questions, which portions (e.g., columns, rows, data types, etc.) of datasets can be accessed, and so on. In addition, the customizations that the administrator selects can specify output characteristics for the chatbot such as the style, formatting, media type (e.g., text, images, text and images, etc.), and other properties of answers.

In some implementations, the customized chatbots can be configured to generate visualizations in response to questions and other user prompts. These visualizations can also be generated through a combination of processing by AI/ML models and non-AI/ML processing systems. For example, if a user prompt requests a visualization or if a visualization is otherwise appropriate for a response, the AI/ML model can specify the type of visualization (e.g., bar chart, line graph, pie chart, etc.) and other properties (e.g., data series shown, scale and data on the axes, etc.). The actual values to be displayed in the visualization, however, can be calculated by the non-AI/ML processing system, using reliable and accurate calculations from the data set. As a result, the AI/ML system can design and format a visualization appropriate to answer the user prompt, while the actual data populating the visualization is not subject to the uncertainties of AI/ML processing.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

In some implementations, a computer system uses artificial intelligence or machine learning (AI/ML) models to generate data visualizations, such as charts, graphs, maps, and so on. The system can generate accurate, high-quality visualizations using a process that leverages the capabilities of AI/ML models, such as large language models (LLMs), as well as the capabilities of data processing systems, such as database management systems. For each visualization generated, the system can use multiple interactions to combine repeatable, accurate data retrieval of a data processing system with the generative and inference capabilities of an AI/ML model.

For example, the system can provide an AI/ML model information about a data set (e.g., a data model for the data set, a data schema for the data set, metadata for the data set, sample data from the data set, etc.) and ask the AI/ML model to generate instructions or code that, when executed, would retrieve the subset of data from the data set that should be shown in a visualization. The system then examines the data retrieval instructions or code generated by the AI/ML model to translate those instructions into as set of characteristics that the visualization should have. For example, the system can use a program or set of rules to extract from the data retrieval instructions or code to a set of parameter values or features that define the visualization, e.g., a visualization type (e.g., line graph, bar chart, pie chart, heatmap, geographical map, etc.), data labels, assignment of values or data series to axes visualization regions, and so on. The system also uses the data retrieval instructions or code generated by the AI/ML model to retrieve data using the data processing system and the system uses the retrieved data to generate the visualization. As a result, the system can generate a visualization of data based on the ability of the AI/ML model to understand natural language understanding and infer relationships, along with the reliable and repeatable results from a data processing system such as a database management system.

Many AI/ML models, such as LLMs, have demonstrated a strong capability for generating text in response to input prompts, with the ability to process natural language input and provide useful text output in various forms. Some AI/ML models have demonstrated strong capabilities to generate software code or other computer instructions that follows the rules or conventions of a programming language, which may be a data manipulation language (DML) or other programming language. In at least some cases, the nature of programming languages facilitates AI/ML models learning these types of outputs, because programming languages often feature the use of predefined terms, relationships, and syntax. As a result, examples of code in training data can show patterns that follow the rules of the programming language and allow those patterns to be learned well by the AI/ML models. By contrast, many AI/ML models that generate images or other visual content produce outputs that can be inconsistent, varying widely in style and characteristics from one request to the next. In addition, AI/ML models for generating images often do not reliably represent values and proportions accurately as is typically expected for data visualizations.

As discussed further below, the present techniques show how visualizations can be generated using the strengths of AI/ML models to interpret natural language and express relationships in a clear manner through data retrieval code or instructions. Rather than asking an AI/ML model to generate a visualization, the system can request that the AI/ML model generate code or instructions to retrieve the data that would be represented in the visualization. A separate, non-AI/ML module can extract the properties of the visualization, and the system can obtain the appropriate data and generate a visualization with the properties determined. This technique can provide various advantages. For example, the AI/ML model is used for functions that it performs well (e.g., natural language interpretation, code generation), instead of for functions that are likely to give highly variable or inconsistent results (e.g., image generation). The AI/ML model can be used to generate an output using a standardized type of code, such as a structured query language (SQL) statement, Python code, etc., for which there is a large set of training data and existing AI/ML models have already exist with the output generation capability. In many cases, an existing model that is capable of generating SQL can be used, without the need to gather training data or expend the significant resources for training an AI/ML model to perform a customized task.

Using the AI/ML model to produce output in a standardized format such as SQL limits ambiguity and expresses relationships in a domain with clear rules and patterns, and much less variation than general text responses. In addition, asking the AI/ML model to specify the data to be obtained focuses the AI/ML model on the characteristics of the data set, and separates the visual design of the visualization. For example, the system is not dependent on the AI/ML model having been trained with appropriate examples of visualizations. The system, in translating from data retrieval code or instructions to visualization properties, can provide consistent styles, formatting, and visual characteristics across different user requests and data sets, which is often challenging for many AI/ML models. The use of a standardized format for the AI/ML model output also facilitates the use of different AI/ML models. Even if the particular AI/ML model is switched or updated, the system can still translate the code or instructions to visualization properties and also provide consistent visual characteristics and reliable accuracy for visualizations across many different AI/ML models.

In one general aspect, a method performed by one or more computers includes: storing, by the one or more computers, a search index for data sets, wherein the search index describes data objects of the data sets and values for the data objects in the data sets; receiving, by the one or more computers, a user prompt to a chatbot; in response to receiving the user prompt, searching, by the one or more computers, for data objects and values that are relevant to the user prompt, including using the search index to search for data objects and values of one or more data sets that the chatbot is configured to access; using, by the one or more computers, one or more results obtained using the search index to generate a chatbot response to the user prompt, including providing the one or more results to an artificial intelligence and/or machine learning (AI/ML) model; and providing, by the one or more computers, the chatbot response as a response to the user prompt.

In some implementations, the one or more results obtained using the search index comprise data objects corresponding to terms of the user prompt.

In some implementations, the one or more results obtained using the search index comprise values corresponding to terms of the user prompt.

In some implementations, the search index includes information determined based on structure and metadata of a data set, including at least one of data table names, data table labels, data table descriptions, column names, column labels, or column descriptions.

In some implementations, the searching comprises identifying elements that are likely to identify or disambiguate references to attributes, metrics, and other data objects referenced in the user prompt.

In some implementations, the one or more results are provided to the AI/ML model such that the one or more results are used by the AI/ML model to determine data objects corresponding to terms or concepts in the user prompt.

In some implementations, the one or more results comprise information that specifies relationships between terms of the user prompt and data objects, such as data indicating the data objects identified as being most closely related to particular words or phrases of the user prompt.

In some implementations, the searching comprises searching for similarity using a vector database, including by comparing the distance of embeddings for terms or concepts of the user prompt with stored embeddings.

In some implementations, the method includes using the search index to identify which data set or data sets, from among multiple data sets, should be used to generate an answer to the user prompt.

In some implementations, the search index comprises content of a semantic graph; and the one or more results comprises items or relationships from the semantic graph.

In some implementations, the search index comprises content of a knowledge base for an organization; and the one or more results comprises items from the knowledge base of the organization.

In some implementations, the search index comprises user preferences or information learned from user interactions; and the one or more results comprises user preferences or information learned from user interaction.

In another general aspect, a method performed by one or more computers includes: providing, by the one or more computers, an interface to receive a user input to an interactive application that is configured to provide responses generated using one or more artificial intelligence or machine learning (AI/ML) models, wherein the interactive application is associated with a data set; receiving, by the one or more computers, a user prompt through the interface, the user prompt comprising natural language text; in response to receiving the user prompt, obtaining, by the one or more computers, code or instructions generated using the one or more AI/ML models, wherein the code or instructions are configured to cause a data processing system to retrieve data that is relevant to the user prompt from the data set; obtaining, by the one or more computers, result data generated from the data set as a result of processing the code or instructions using a data processing system; obtaining, by the one or more computers, natural language text generated by the one or more AI/ML models based on the result data generated from the data set; and providing, by the one or more computers, a response to the user prompt through the interface, wherein the response is based on the natural language text generated by the one or more AI/ML models based on the result data.

In some implementations, obtaining the code or instructions comprises providing a first request to the one or more AI/ML models, wherein the first request requests code or instructions specifying data processing criteria to retrieve or generate result data to answer the user prompt; and obtaining the natural language text generated by the one or more AI/ML models comprises providing a second request to the one or more AI/ML models, wherein the second request provides the result data and requests an answer to the user prompt.

In some implementations, providing the first request comprises providing the first request to a third-party AI/ML service provider; the data processing system is separate from the third-party AI/ML service provider; providing the second request comprises providing the second request to the third-party AI/ML service provider, wherein the second request includes result data; and, to generate the response to the user prompt, the third-party AI/ML service provider does not receive access to content of the data set other than to receive the result data.

In some implementations, the method includes: in response to receiving the user prompt, selecting from one or more knowledge bases, knowledge base content that is determined to be relevant to the user prompt; and providing the selected knowledge base content with the first request or the second request.

In some implementations, obtaining the code or instructions generated using the one or more AI/ML models comprises: generating a request to the one or more AI/ML models that includes (i) an instruction to generate code or instructions to retrieve data from the data set based on the user prompt, and (ii) a data model or data schema that indicates logical objects of the data set; and receiving output that the one or more AI/ML models generated, including code or instructions that specify data processing criteria expressed using references to one or more of the logical objects from among the logical objects of the data set that are indicated by the data model or data schema.

In some implementations, the logical objects comprise metrics or attributes available from the data set; and the code or instructions refer to one or more of the metrics or attributes using a name or identifier specified in the data model or data schema for the one or more of the metrics or attributes.

In some implementations, the code or instructions generated by the one or more AI/ML models specify one or more operations that express one or more criteria specified in natural language in the user prompt and are configured to retrieve, filter, sort, rank, or aggregate data from the data set.

In some implementations, the code or instructions comprise a structured query language (SQL) statement generated by the one or more AI/ML models.

In some implementations, the request includes content from one or more knowledge bases that specify a set of definitions or descriptions of terms for an organization, wherein the one or more knowledge bases are updated separately from the one or more AI/ML models.

In some implementations, the interactive application is a chatbot, and wherein the method includes initializing a session of the chatbot including providing content of the one or more knowledge bases to the one or more AI/ML models such that the content of the one or more knowledge bases is used as context for responding to the user prompt.

In some implementations, the content of the one or more knowledge bases is shared across multiple chatbots, such that updates to the one or more knowledge bases update the knowledge available to each of the multiple chatbots for interpreting user prompts.

In some implementations, obtaining the result data generated from the data set as a result of processing the code or instructions using a data processing system comprises processing the code or instructions using a database system.

In some implementations, obtaining the natural language text generated by the one or more AI/ML models based on the result data generated from the data set comprises: providing a request to the one or more AI/ML models to answer the user prompt based on the result data, wherein the request includes (i) the user prompt and (ii) the result data.

In some implementations, the interactive application comprises a chatbot; and the one or more AI/ML models comprise a large language model.

In some implementations, providing the interface comprises providing data for a user interface of a web page or web application.

In some implementations, providing the interface comprises providing an application programming interface.

In some implementations, the interactive application is configured to vary which portions of the data set are used to provide responses by the interactive application to different users based on respective permissions or access levels of the different users.

In some implementations, the method includes generating visualization data for a visualization of the result data; and providing the visualization data in the response to the user prompt.

In some implementations, the one or more AI/ML models are provided by or operated by a third party. The interactive application is configured to generate responses to user prompts based on (i) generating result data to the user prompts from the data set using the data processing system, and (ii) providing the generated result data to the third party, so that the third party generates content for the responses without direct access to the data set and without receiving content of the data set other than the result data.

In some implementations, the result data is generated by a database management system based on a query or set of processing operations determined using the user prompt. The interactive application is configured to obtain response content from the one or more AI/ML models by requesting that the one or more AI/ML models answer the user prompt using the result data or summarize the result data.

In another general aspect, a method performed by one or more computers includes: receiving a user prompt; sending a first request to the one or more AI/ML models based on the user prompt, wherein the first request requests instructions for analyzing the data set based on the user prompt; causing data processing instructions that the one or more AI/ML models generated in response to the first request to be carried out using deterministic processing of a data processing system separate from the AI/ML models; sending a second request to the one or more AI/ML models, including results generated by carrying out the data processing instructions and a request to generate text based on the results; and providing, in a response to the user prompt, text that the one or more AI/ML models generated in response to the second request.

In some implementations, the first request is a request for instructions specified in code of a programming language; and causing the data processing instructions to be carried out comprises causing the instructions or operations specified by the code of the programming language to be performed.

In some implementations, the interactive application is configured to respond to at least some user prompts with data for a visualization of result data from the data set.

In some implementations, the interactive application is configured to request and receive data describing characteristics of a visualization of the result data from the one or more AI or machine learning models.

In some implementations, the visualization comprises a chart or graph of a type of data indicated by the one or more AI or machine learning models based on information from a user prompt, with the chart or graph depicting values for the type of data wherein the values are determined by a database system separate from the one or more AI/ML models.

In some implementations, the visualization comprises a chart or graph of the result data, and properties of the visualization are derived from code or instructions generated by the one or more AI/ML models.

In another general aspect, a method performed by one or more computers includes: providing, by the one or more computers, an interface for creating or editing an interactive application configured to provide responses generated using one or more artificial intelligence (AI) or machine learning models; receiving, by the one or more computers, customization data through the interface, wherein the customization data indicates customizations specified by a user to customize the interactive application, wherein the customization data identifies a data set for the interactive application and specifies one or more characteristics of behavior of the interactive application; storing, by the one or more computers, one or more records specifying configuration settings representing the customizations for the interactive application; and providing, by the one or more computers, access to the interactive application with the customizations for one or more users, such that the interactive application is configured to generate a response to a user prompt using (i) a result determined from the data set based at least in part on the user prompt and (ii) content generated by the one or more AI or machine learning models from processing the result determined from the data set.

In some implementations, the interactive application comprises a chatbot, and the one or more AI or machine learning models comprises a large language model.

In some implementations, providing the interface comprises providing data for a user interface of a web page or web application.

In some implementations, providing the interface comprises providing an application programming interface.

In some implementations, providing the interface comprises providing user interface data for a user interface comprising (i) a set of interactive elements to that are selectable by a user to change settings of the interactive application, and (ii) a region for interacting with the interactive application, including an input control configured to submit user prompts and an output area configured to provide responses of the interactive application to the user prompts.

In some implementations, the interface includes one or more controls to alter an appearance of the interactive application; the customization data indicates customizations specified by the user that include changes to the appearance of the interactive application; and the stored one or more records indicate the changes to the appearance of the interactive application.

In some implementations, the interface includes one or more controls to alter one or more messages to provide to users of the interactive application; the customization data indicates customizations specified by the user that include the one or more messages; and the stored one or more records indicate the one or more messages to provide to users of the interactive application.

In some implementations, the interface includes one or more controls to set whether the interactive application can use information from the Internet to respond to user prompts; the customization data indicates customizations specified by the user that include a setting whether the interactive application can use information from the Internet to respond to user prompts; and the stored one or more records indicate the setting whether interactive application can use information from the Internet to respond to user prompts.

In some implementations, the interface includes one or more controls to control access to the interactive application by users; the customization data indicates customizations specified by the user that adjusts which users can access the interactive application; and the stored one or more records indicate criteria specifying which users can access the interactive application.

In some implementations, the interface includes one or more controls to limit an amount of usage of the interactive application by users; the customization data indicates customizations specified by the user that set a limit on the amount of usage of the interactive application by users; and the stored one or more records indicate the limit on the amount of usage of the interactive application by users.

In some implementations, the interface includes one or more controls to limit the portions of the data set that can be used to generate responses provided by the interactive application; the customization data indicates customizations specified by the user that specify a subset of the data set to be used by the interactive application to generate responses; and the stored one or more records indicate the subset of the data set to be used by the interactive application to generate responses.

In some implementations, the interactive application is configured to vary which portions of the data set are used to provide responses by the interactive application to different users based on respective permissions or access levels of the different users.

In some implementations, the one or more AI or machine learning models comprises a third-party AI or machine learning model; and the interactive application is configured to generate responses to user prompts based on (i) generating results to the user prompts from the data set using a data processing system, and (ii) providing the generated results to the third-party AI or machine learning model, so that the third-party AI or machine learning model generates content for the responses without direct access to the data set.

In some implementations, the result comprises result data generated by a database management system based on a query or set of processing operations determined using the user prompt; and the interactive application is configured to obtain the content from the one or more AI or machine learning models by requesting that the one or more AI or machine learning models summarize results from the database system.

In some implementations, the interactive application is configured to generate a response to a user prompt by performing operations including: sending a first request to the one or more AI or machine learning models based on the user prompt, wherein the first request requests instructions for analyzing the data set based on the user prompt; causing data processing instructions that the one or more AI or machine learning models generated in response to the first request to be carried out using deterministic processing of a data processing system separate from the AI or machine learning models; sending a second request to the one or more AI or machine learning models, including results generated by carrying out the data processing instructions and a request to generate text based on the results; and providing, in a response to the user prompt, text that the one or more AI or machine learning models generated in response to the second request.

In some implementations, the first request is a request for instructions specified in code of a programming language; and wherein causing the data processing instructions to be carried out comprises causing the instructions specified by the code of the programming language to be performed.

In some implementations, the interactive application is configured to respond to at least some user prompts with data for a visualization of data from the data set, wherein the interactive application is configured to request and receive data describing characteristics of the visualization from the one or more AI or machine learning models.

In some implementations, the visualization comprises a chart or graph of a type of data indicated by the one or more AI or machine learning models based on information from a user prompt, with the chart or graph depicting values for the type of data wherein the values are determined by a database system separate from the one or more AI or machine learning models.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A and 1B are diagrams showing an example of a system for creating, distributing, and using chatbots.

FIGS. 2A and 2B show examples of chatbot interfaces.

FIG. 3 shows an example of data processing for a chatbot, where search capabilities improve the interpretation of a user prompt by a chatbot and the generation of a response to the user prompt.

Like reference numbers and designations in the various drawings indicate like elements.

### DETAILED DESCRIPTION

In some implementations, a computer system provides functionality for creating and distributing customized interactive applications, such as chatbots, that provide responses using artificial intelligence or machine learning (AI/ML) models, such as large language models (LLMs). For example, the computer system can provide an interface through which a user, such as an administrator, can create or edit an interactive application. The computer system can provide an initial base application or template that includes the core functionality that enables users to obtain content from an AI/ML model. The administrator can use the interface customizations that alter the appearance and behavior of the interactive application, so the customized application provided to users will operate as the administrator intends. The customizations can include, for example, specifying the data sources available to be used in responding to user prompts (e.g., questions or statements input to a chatbot), as well as whether information from the Internet or other external sources can be used in generating responses. The interface also allows the administrator to set user access control and usage limits for the interactive application, to control resource consumption and costs incurred by repeated inference processing using AI/ML models.

After the administrator customizes the interactive application using the interface, the computer system saves the interactive application (e.g., as a new or updated chatbot) and makes the application available to other users. For example, the computer system can send hyperlinks or invitation messages to users, so the users can access a customized chatbot through a web page or web application. As another example, the computer system can include code to integrate the customized chatbot into an existing web page or web application (e.g., as an embedded item, in an iFrame, etc.). As another example, the computer system can integrate with document libraries, file browsers, document viewers, web browsers, or other types of user interfaces. As a result, the customized chatbot can be made available through any of various enterprise software platforms and applications. The interface of the customized chatbot can then be invoked by interacting with an icon or menu item for the customized chatbot, or by entering a user prompt into a text entry field of a user interface. In some implementations, the interface of the chatbot can be provided together with a document viewer, for example, in a sidebar or tab shown concurrently with the document viewer interface. This arrangement can enable the user to view a document, such as a dashboard related to a dataset, while concurrently having a conversation with a customized chatbot designed to answer questions about the dataset.

The computer system enables interactive applications to be tailored or targeted for specifics data sets. For example, each interactive application that is created or customized can provide responses with information derived from a corresponding data set specified by the administrator, such as a private data set (e.g., a database table, a data cube, a spreadsheet, etc.). The system enables administrators to create and deploy multiple interactive applications concurrently. For example, different chatbots that have different behavior tailored for different sets of users. Similarly, different chatbots can be configured to provide data from different source data sets. Administrators can create and deploy different instances of chatbots and other interactive applications, each with customized behavior, appearance, and other characteristics as appropriate for their respective data sets and users.

The computer system enables administrators to customize AI/ML-enabled chatbots very quickly, without the need to re-train an AI/ML model. In particular, after specifying the customizations for the chatbot, no model training is needed and so the customized chatbot can be used right away. The system can provide a preview interface or test interface that enables an administrator to change chatbot settings and try out the updated chatbot in the generation or editing interface, to see the effects of changes in real time or near real time. To facilitate customizability and the rapid generation of chatbots, the customizations to the chatbot can be made outside the training state of the AI/ML chatbot itself, for example through the selection of which existing AI/ML model(s) to be used, which dataset(s) being used, which portions of a dataset are accessible, and the parameters or characteristics of interactions with the AI/ML model(s). Customizations can also be implemented in operations of a non-AI/ML processing system, for functions such as access control, precision or granularity of data access, and so on. With the ability to provide customized chatbots without the need to train or re-train AI/ML models, the system allows rapid generation and deployment of chatbots with minimal up-front computing resources and no training delay.

The computer system can support interactive applications where processing tasks for responding to a user prompt are split between non-AI/ML or non-probabilistic data processing systems AI/ML models (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model—and any third-party providing the AI/ML model as a service-access to portions of the dataset that are not appropriate for answering the current question.

The customizations that the administrator set in creating or customizing the chatbot can be used to alter the operation and results of the non-AI/ML data processing system, the AI/ML model, the front-end interface that the user sees, or a combination of any or all of them. For example, the customizations that the administrator selects can specify which dataset(s) to use when answering questions, whether additional public datasets or the Internet can be used to answer questions, which portions (e.g., columns, rows, data types, etc.) of datasets can be accessed, and so on. In addition, the customizations that the administrator selects can specify output characteristics for the chatbot such as the style, formatting, media type (e.g., text, images, text and images, etc.), and other properties of answers.

In some implementations, the customized chatbots can be configured to generate visualizations in response to questions and other user prompts. These visualizations can also be generated through a combination of processing by AI/ML models and non-AI/ML processing systems. For example, if a user prompt requests a visualization or if a visualization is otherwise appropriate for a response, the AI/ML model can specify the type of visualization (e.g., bar chart, line graph, pie chart, etc.) and other properties (e.g., data series shown, scale and data on the axes, etc.). The actual values to be displayed in the visualization, however, can be calculated by the non-AI/ML processing system, using reliable and accurate calculations from the data set. As a result, the AI/ML system can design and format a visualization appropriate to answer the user prompt, while the actual data populating the visualization is not subject to the uncertainties of AI/ML processing.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

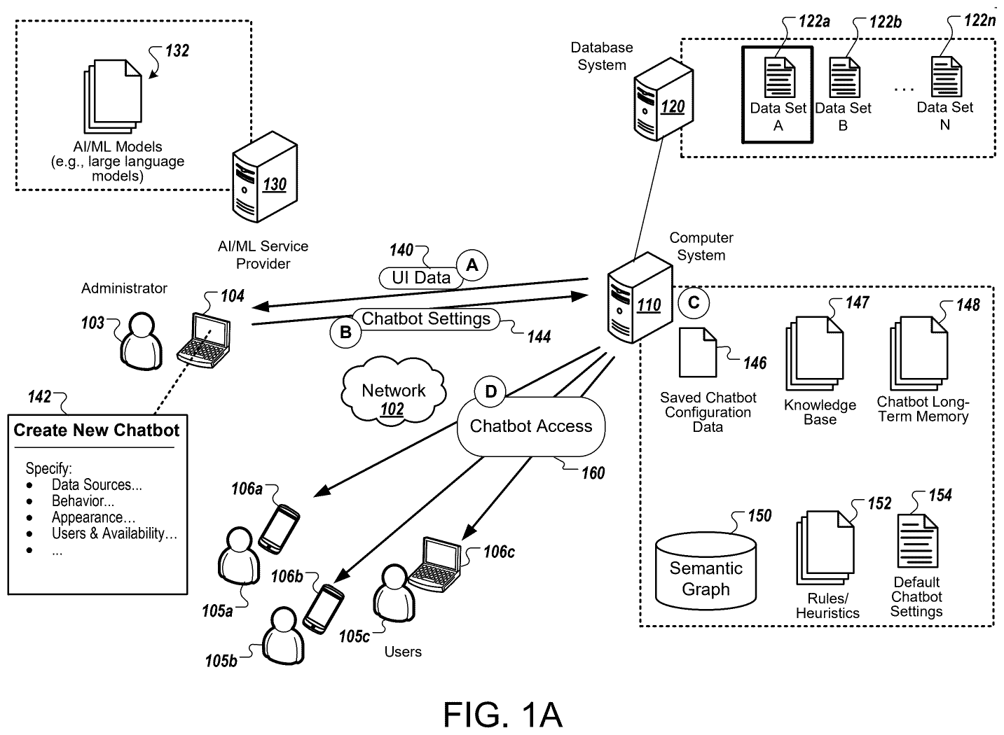

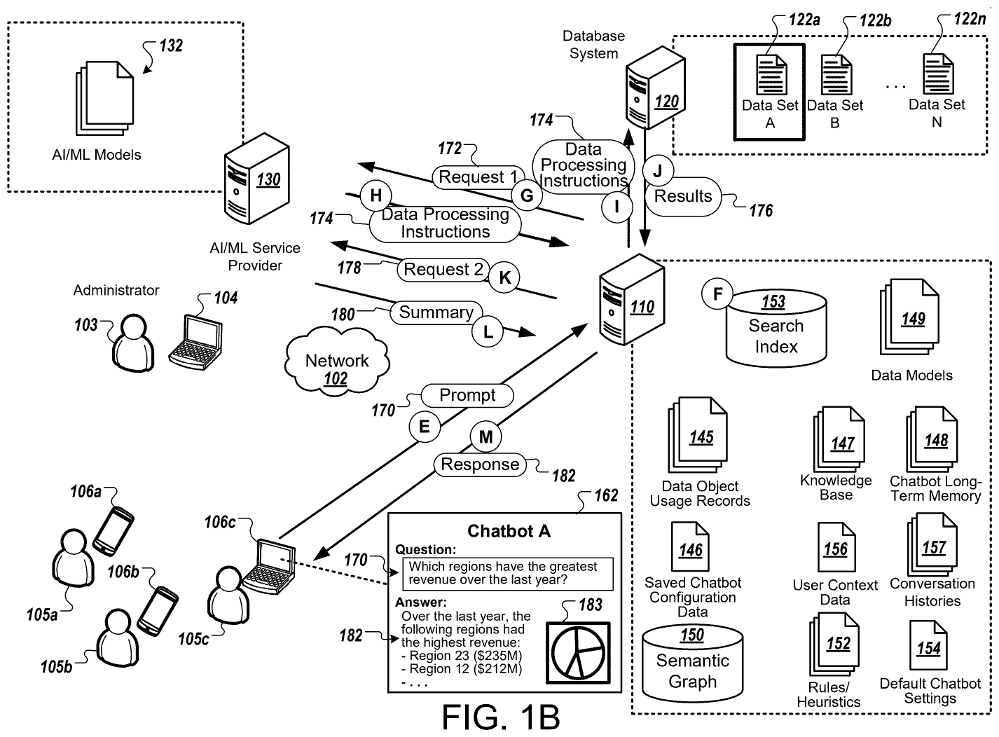

FIGS. 1A-1B are diagrams showing an example of a system 100 for creating, distributing, and using interactive applications such as customized chatbots. The system 100 includes a computer system 110, a database system 120, and a AI/ML service provider 130. The elements of the system 100 communicate over a network 102, such as the Internet. The computer system 110 coordinates a variety of functions for creating and operating chatbots. For example, the computer system 110 interacts with a client device 104 of an administrator 103 to receive customization data that indicates customizations for a chatbot. The computer system 110 then provides access to the customized chatbot to client devices 106a-106c of other users 105a-105c, and the computer system 110 coordinates processing to generate and provide answers to questions and other user prompts provided to the customized chatbot.

The example of FIGS. 1A-1B includes stages (A) to (L), which represent various operations and a flow of data, and which can occur in the order illustrated or in a different order. In FIG. 1A, stages (A) to (D) show an example of creation of a customized chatbot and access being provided to users. In FIG. 1B, stages (E) to (L) show an example of the customized chatbot being used, from issuance of a question or prompt 170 from a user to display of a response 182 from the customized chatbot.

The computer system 110 can be implemented using one or more servers, including one or more cloud computing systems. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. As discussed further below, the computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

As an overview, to create a customized chatbot, the administrator 103 interacts with the computer system 110 to specify the features and behavior that are desired for the chatbot. Through a series interactions, the administrator 103 can specify characteristics such as which dataset(s) 122a-122n the chatbot will use to generate responses, the appearance and style of the chatbot interface, whether the chatbot can access data from the Internet or other sources, access control settings, and so on. The computer system 110 saves the settings specified by the administrator 103 and creates a new chatbot

To provide the interface, the computer system 110 can provide data for a web application, web page, or native application that, when rendered on a client device, provides the functionality to specify settings of the chatbot being created or edited.

In stage (A), the computer system 110 provides user interface data 140 to the client device 104 over the network 102. For example, the computer system 110 can provide content of a web page or web application for creating or editing the customized chatbot. The user interface data 140 is rendered on the display of the client device 104, represented by user interface 142.

The user interface 142 provides controls to specify many different properties of the chatbot. For example, the user interface 142 enables the administrator 103 to specify the data source or dataset that the chatbot will draw from to provide responses. The user interface 142 also allows the administrator 103 to specify various aspects of the behavior of the chatbot, including suggestions, instructions to the user, and more. The user interface 142 also includes controls for the administrator 103 to specify characteristics of the appearance of the chatbot, including color schemes, layout, formatting, size, and other characteristics. The user interface 142 also includes controls for the administrator 103 to specify access control, such as to specify which users can access the chatbot, the number or frequency of questions users are permitted issue to the chatbot, the platforms or interfaces in which the chatbot is available, and so on.

In stage (B), the administrator 103 uses the interface 142 to enter the settings that customize the appearance and operation of the chatbot. The client device 104 sends the specified settings 144 to the computer system 110 over the network 102.

As an example, the administrator 103 selects a particular dataset 122a as the data source for the chatbot, as a result, the chatbot will generate responses based on the information in this dataset 122a. In some implementations, each chatbot is focused on a specific dataset or collection of records. This can allow the chatbot to be tailored closely to a specific application, task, purpose, or set of users or roles in an organization. In addition, limiting the scope of data that the chatbot can access can improve accuracy in responses by limiting the amount of extraneous information that might otherwise be introduced. In addition, focusing a chatbot on a specific dataset can increase performance and reduce response times, by reducing the complexity and amount of data that needs to be processed to generate answers.

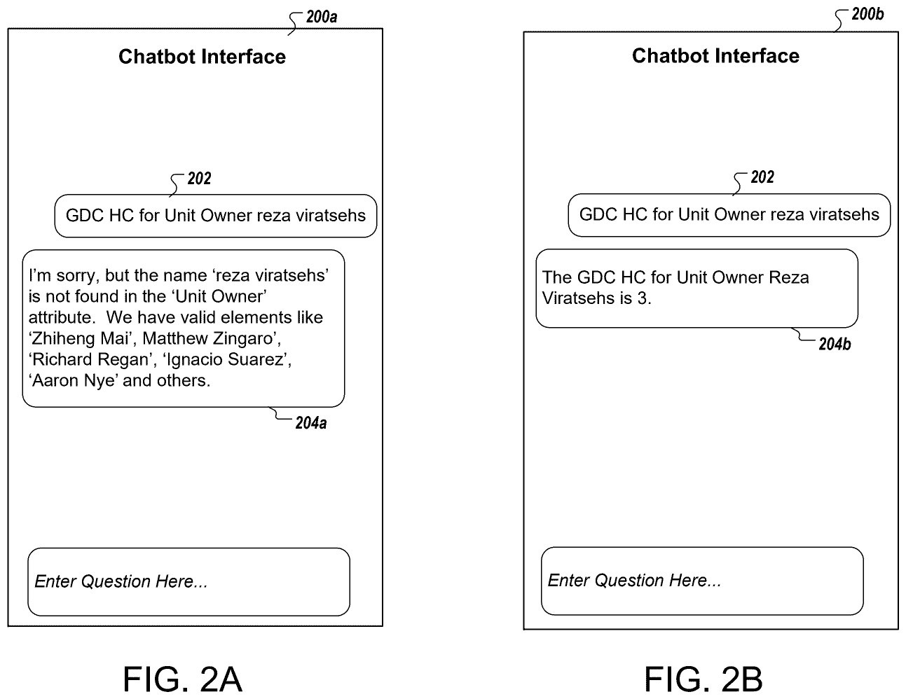

The process of specifying the settings for the chatbot can be iterative, with potentially multiple rounds of the administrator 103 interacting with the user interface 142 to incrementally adjust and test the settings of the chatbot. For example, as discussed below for FIG. 6A, the user interface 142 can provide a preview area or test panel in which the chatbot can run and provide interactions with the administrator 103 during the process of specifying the customized chatbot settings 144. As the administrator 103 makes changes to the chatbot settings, the administrator 103 can issue questions to the chatbot and evaluate the responses and interaction behavior with the newly updated settings, allowing the administrator 103 to make further changes based on the results experienced. FIGS. 2-6E, discussed further below, show examples of the user interface 142 and further illustrate the types of settings that can be adjusted to customize the chatbot.

Referring still to FIG. 1A, in stage (C), the computer system 110 uses the customized chatbot settings 144 from the administrator 103 to generate and save the data and settings that define the chatbot. In the example, this is shown as saved chatbot configuration data 146. For example, the computer system 110 can create a record or series of records representing the new chatbot and its customized settings. For each chatbot, the computer system 110 saves a separate set of records or definitions that specify the characteristics and customizations of that chatbot. For example, each chatbot can have a set of saved chatbot configuration data 146 that specifies, among other items, the name of the chatbot, the dataset for the chatbot, a selection of which AI/ML models 132 to use for the chatbot, the appearance and formatting characteristics of the chatbot, access control information for the chatbot, customized instructions to append to or include in user prompts to AI/ML models, and so on.

The computer system 110 can include a number of modules and datasets that facilitate the generation of new chatbots. For example, the computer system 110 can include a set of default chatbot settings 154 that provides a default or base configuration for new chatbots. The customizations specified in the received chatbot settings 144 can override or replace settings in the default set of chatbot settings 154 to form the final set of saved chatbot configuration data 146.

Generating and saving the chatbot can include registering the chatbot with a number of different applications, web pages, web applications, or other services. For example, the computer system 110 can register the new chatbot, with its name, capabilities, and applicable context, so that the option for the chatbot appears for users who have been granted access. For example, the chatbot can be made available through the document libraries of users who are approved to access the chatbot.

In some implementations, the computer system 110 enables the administrator 103 to attach one or more additional data sets to adjust the operation and output of the chatbot. For example, an additional data set can be a knowledge base 147 or data dictionary can be added. Unlike the primary data set that the user selects for the chatbot (e.g., data set 122a), the chatbot is not configured to answer questions about the additional data set or to retrieve metrics or to provide visualizations of the knowledge base 147. Instead, the knowledge base 147 can be provided to assist the chatbot in interpreting user queries and providing responses with the terminology for the user's organization. In general, the knowledge base 147 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 147 is designated for the chatbot to describe these and other internal terms. Each time the user submits a prompt, the knowledge base 147 can be provided to assist the LLM with the context that is appropriate for the company. The knowledge base 147 can provide information similar to a semantic graph, by describing entities and their relationships. In some cases, the information in the knowledge base 147 can be derived from a semantic graph 150 and then converted into text (e.g., unstructured, semi-structured, or structured) in a format that can be processed by the LLM.

In general, the knowledge base 147 or other additional data set can include data that maps terms or phrases to their meanings. In many cases, this can include semi-structured data or explanatory content, as a way to explain entities and relationships wo the AI/ML models 132. Although the knowledge base 147 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 147 as contextual data sets that can be applied consistently across the enterprise, for all chatbots created and used in the enterprise. Similarly, different departments within the enterprise may add their own particular contextual data sets that may supplement the enterprise-wide knowledge bases 147. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 147 is consistency for many users and even for many different chatbots of an organization. The user submitting a prompt does not need to take any action to select or include the knowledge base 147 in the chatbot's processing, the chatbot automatically include the knowledge base 147 in its context for each prompt or question received. Also, because the knowledge base 147can be shared or inherited by many chatbots within an organization, updating and maintaining the knowledge base 147 is simple. An edit to the knowledge base 147is automatically applied to all of the chatbots associated with the organization, even if the chatbots were created by different administrators or provided to different sets of users.

In addition, the knowledge base 147 provides persistent context that is not lost from one prompt to another or from one session to another. The knowledge base content can also be implemented applied in a manner that the knowledge base 147 does not count toward the instruction token limits that the AI/ML models 132 consume for each response. Rather than counting toward the tokens for prompts and recent history, the knowledge base 147 can be accessed or provided to the AI/ML models 132 as a separate source of knowledge apart from the prompt and context, and so does not count toward the token limits of an LLM. Implementations of access to the knowledge base 147can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 147can be prepared as an embedding, a vector database, or other format that can be accessed by or referred to by the AI/ML models 132.

With the additional knowledge chatbot has three general sources of information before even receiving the user prompt. First, the chatbot has the primary dataset (e.g., data set A 122a) selected by the administrator 103, which is the primary source of answer for the chatbot. Second, the chatbot has a set of instructions that the administrator 103 provided, e.g., general instructions such as the description of the primary dataset, the purpose of the chatbot, the type of user or type of task interacting with the chatbot, and a description of how the chatbot should form responses (e.g., response format, types of data to include, order of elements to include, etc.). Third, the chatbot has the knowledge base, which provides additional context behind the purpose of the bot and how the customer defines things. These types of information form a base level of information that is available for all users that use the chatbot. Also, for each user, the chatbot receives the user's prompt and also receives information about the conversation history of the user (e.g., previous queries and responses, from the current session and/or prior sessions).

In some implementations, the chatbot is designed to have a long-term memory 148, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 148 for the chatbot. For example, the long-term memory 148 can store items such as definitions of terms for a particular user context, unique text elements the chatbot might encounter, and feedback from prior user interactions.

One valuable aspect of the long-term memory 148 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

The learning of the chatbot is managed by the computer system 110 and happens on an ongoing basis as users interact with the chatbot. The information learned is stored outside the LLM or other AI/ML models 132, and is stored in the long-term memory 148 designated for the chatbot. Each chatbot that is created can have its own long-term memory 148, which is updated by the interactions of its own users. Before the computer system 110 asks the stateless LLM to provide a response to a user prompt, the computer system 110 facilitates retrieval of data from the long-term memory 148, potentially to provide customized instructions or additional contextual data to accompany the user prompt and tailor the response based on what has been learned from prior interactions. The long-term memory 148 thus provides better reference data for LLM to use in guiding answer generation.

The long-term memory 148 can include business definitions of other users have specified or uploaded. In this way, the long-term memory 148 can supplement or expand on the descriptions provided in the knowledge base 147. The chatbots can be configured to learn at different levels, e.g., at the level of individual users, at the level of a department or group of users, and for an enterprise as a whole. In other words, the preferences of an individual may be learned and applied for that individual. In addition, the aggregate preferences learned for many individuals can be combined to also adjust the chatbot, to accelerate the adaptation of the chatbot to meet the needs of the user base. In some implementations, the computer system 110 can use access control lists and permissions for users to apply security policies to adjust access and appropriately set the context for each user.

In stage (D), the computer system 110 provides access to the chatbot to various users. 105a-105c. For example, the chatbot settings 144 specified by the administrator 103 can specify access control parameters that indicate groups of users or individual users or categories of users who receive access to the new chatbot. The computer system 110 provides access to the chatbot to authorized users in any of various ways. For example, the computer system 110 can send a message to authorize users with a URL or other link to web page, web application, or native application functionality providing the chatbot interface. As another example, the computer system 110 can update and interface such as a document library, dashboard, or other user interface to include a panel with the chatbot interface, or to include an icon, button, or other control that is interactive so that users can interact to request that the chatbot interface be provided.

Referring to FIG. 1B, after the chatbot has been customized and saved, a user 105c interacts with the chatbot. For example, the user 105c accesses a user interface 162 for the chatbot. The user interface 162 includes a field in which the user can enter a question or other user prompt 170. In the example, the user 105c enters the prompt 170, and the user's client device 106c sends the prompt 170 to the computer system 110 for processing. The computer system 110 receives the prompt 170 and begins a series of interactions used to generate the response to the prompt 170.

As discussed above, the chatbot has an associated knowledge base 147 that can include, for example, descriptions of terms that may have a unique meaning in the particular context of the user. The knowledge base 147 may be shared by multiple chatbots or even all chatbots associated with the company or organization of the user. When the computer system 110 establishes a new session of the chatbot and a user, the computer system 110 can provide the knowledge base 147 as part of initializing the session with the AI/ML model 132. As a result, the knowledge base 147 can provide additional context for all of the subsequent interactions with the AI/ML model 132.

In addition, the chatbot has information in its long-term memory 148 that has been learned through previous interactions with users. This information can be provided upon initialization of the chatbot, as the knowledge base 147 is, or can be provided in other ways. For example, the information from the long-term memory 148 can be selectively and contextually applied, as the computer system 110 analyzes the prompt 170 and determines whether there is information in the long-term memory 148 that is relevant to the content of the prompt 170. The retrieved content of the long-term memory 148 that the computer-system 148 determined to be relevant to the prompt, can then be provided with the prompt 170. As another example, certain information in the long-term memory 148 may be applicable to a specific user, role, or permission level, and the computer system 110 can provide that information in response to determining that the user 105c submitting the prompt 170 is that user or has that role or permission level. In other cases, the information in the long-term memory 148 supplements or alters the general instructions or initialization commands for starting the chatbot session, either in all cases or selectively when specific prompt content or user context is detected.

In stage (F), the computer system 110 uses a search index 153 to search for information that can assist the AI/ML model 132 to interpret the user prompt 170. This information can assist the AI/ML model 132 to more accurately map terms of the user prompt 170 to data objects of the data set 122a that the chatbot is configured to use to respond to user prompts. For example, the additional context that the computer system 110 adds as a result of the search can enable the chatbot to effectively handle queries with inaccurately named elements, ambiguous attributes, or typographical errors. In general, the computer system 110 can provide infrastructure that automatically pinpoints and indexes the most frequently utilized attributes or attribute forms within datasets, particularly those heavily used chatbots and other AI/ML features. The computer system 110 can search for elements in the data set that are similar or conceptually closest to terms in the user prompt 170. By providing the results of the search, the AI/ML model 132 will be able to more accurately select from among the available data objects when interpreting the user prompt 170.

The computer system 110 can use various techniques to search for relevant information that can aid the AI/ML model 132 in interpreting the user prompt 170. For example, the computer system 110 can search for matches to terms of the user prompt or conceptually similar content among content of a data model 149 or metadata describing the data objects in the data set 122a. As another example, the computer system 110 can search for matches to terms of the user prompt or conceptually similar content among the values in the data set 122a itself. As another example, the computer system 110 can search for matches to terms of the user prompt or conceptually similar content among content of the semantic graph 150 or one or more knowledge bases 147. In addition, or as an alternative, the computer system 110 can use data object usage records 145 to identify which data objects are used most commonly or most frequently. The computer system 110 can use the data object usage records 145 to rank or select data objects, or to assign scores to data objects, so the frequency that different objects are used (by the current user 105c or by a larger group of users) can guide the AI/ML model 132 to using the more frequently used data objects, especially if it is otherwise unclear which data object should be used.

In further detail, the search index 153 can be populated with information resulting from indexing the data model 149 for the data set 122a or other metadata describing the data objects of the data set 122a. For example, the names or labels for the attributes and metrics available from the data set 122a can be indexed, along with information describing the type of data represented by those attributes and metrics. With this information, the computer system 110 can search using the search index 153 to find when terms of the user prompt 170 match or are similar to the names and descriptions of the available data objects. The computer system 110 can then indicate to an AI/ML model 132 the data object(s) identified as most similar to each of the terms of the user prompt 170.

The search index 153 can also include an index of the content of the data set 122a itself. For example, the search index 153 can include information that indicates values of the data set 122a and the data set elements (e.g., particular data tables or columns) or data objects (e.g., particular metrics or attributes) that include those values. In response to receiving the user prompt 170, the computer system 110 can use the search index 153 to find instances of terms used in the user prompt 170, and the data set elements or data objects in which those instances occur. For example, if a user prompt includes the term “New York,” the computer system 110 can search to determine whether the data set 122a includes the term “New York,” and if so, which data object (e.g., which metric, attribute, or column of data) includes the term. Instances of the term in values of a data object can be a strong indicator that the data object is relevant to the term. In some cases, there may be multiple data objects that include the same term, and the relative amount of records having the term as a value for the different data objects can be an indicator of which data object may be a more appropriate for the term.

In some implementations, the search index 153 is a vector database or other system that enables conceptual searching or semantic searching. A vector database can store information by representing it with an embedding or position in a high-dimensional vector space. To retrieve relevant information, the computer system 110 system can also represent the user prompt, or separate chunks or portions of the user prompt, in the vector space. The computer system 110 can search for information that is conceptually or semantically similar to the terms of the user prompt by comparing the position of the vector representation of user prompt terms with the vector representation of the stored information (e.g., a data object label or description, values in the data set 122a, etc.). The computer system 110 can identify the data sets and data objects that that are closest to the terms of the user prompt in the vector space, where the closest data sets and data objects are most similar to the concepts of the terms in the user prompt. In this manner, even if the user prompt includes an incorrect spelling or other non-standard form, the conceptual or semantic search can find similar items that are still relevant to the user prompt.

The search index 153, whether implemented using a vector database or in another form, can store information about portions of knowledge bases 147 and/or the semantic graph 150 for an organization. The computer system 110 can search for items from the knowledge bases 147 and/or the semantic graph 150 that can provide important context for interpreting terms of the user prompt 170, even though these may items may not individually map terms to data objects. In many cases, an item from a knowledge base 147 or from the semantic graph 150 may provide one link or connection that, together with other items, forms a chain of connections that tie a term in a prompt to a data object in a data set. By identifying and providing the individual items to an AI/ML model 132, in many cases the AI/ML model 132 can connect the relevant items to map a term to an appropriate data object.

For example, a prompt may ask for the “performance of blue team.” The computer system 110 may search and identify from a knowledge base 147 a statement that “blue team” refers a specific user group in the accounting department. The computer system 110, may search and find another item in the knowledge base 147 or the semantic graph 150 that indicates that “performance” for the accounting department is based on the amount of late report submissions. By providing these two search results to an AI/ML model 132, along with a data model 149 that indicates the attributes and metrics available, including those for user group membership, employee identifiers, late report count, and so on, enables the AI/ML model 132 to combine these pieces of information to interpret “performance of blue team” to be a value of the late report submission data object, aggregated across the group of users in the “blue team” group.

As another example, instead of finding the information among a knowledge base 147 or the semantic graph 150, the computer system 110 may search using the search index 153 and find instances of the term “blue team” as values for a “user group” data object. In addition, the computer system 110 may determine from indexed information from a data model 149 that a “late report submission count” data object is associated with the term “performance,” based on vector similarity, metadata or a label describing that data object, etc. The computer system 110 can then provide, to the AI/ML model 132, the data objects respectively identified for the terms “performance” and “blue team,” enabling the AI/ML model 132 to interpret the prompt “performance of blue team” to be an aggregation of values of the “late report submission count” data object, filtered to the set of records having values of “blue team” in the “user group” data object.

The computer system 110 can obtain information from data object usage records 145 and provide it, or information derived from it, to an AI/ML model 132 to better process the user prompt 170. For example, the data object usage records 145 can include counts or other statistics indicating the count or frequency of accesses to different data objects of the data set 122a. This information can be calculated and determined for the current user 105c or for a group of users. Similarly, the information can be calculated for interactions with the chatbot, or more generally for interactions with a wider range of functionality (e.g., including interaction with or use of the data objects in documents, web pages, web applications, etc. in addition to in chatbots). The computer system 110 can be configured to provide usage statistics for data objects in combination with the data model 149, so that the relative frequency of use or likelihood of use of different data objects indicated by the data model 149 can be used by the AI/ML model 132.

As another example, the computer system 110 can use the usage statistics to rank or disambiguate different options for mapping a term to a data object. For example, when performing a search using the search index 153 for a user prompt that includes “New York,” the computer system 110 may identify that “New York” occurs as a value in each of (1) an attribute for “City” in a customer data table (e.g., as part of “New York City,” (2) an attribute for “State” in the customer data table, (3) an attribute for “City” in a supplier data table, (4) an attribute for “State” in the supplier data table, and (5) an attribute for “Location” in a sales data table (e.g., corresponding to a store location or sales region). From these, the number of instances of “New York” in each column of data does not indicate which data object would be the best interpretation for the term as used in the prompt. However, the data object that the user 105c has used most recently, most frequently, or most extensively is an indicator that it may be what the user 105c intended. As an example, the computer system 110 can calculate from the data object usage records 145 the amount of references or interactions that the user 105c had with each of the five different attributes that the search indicated to be relevant to the term “New York.” The computer system 110 can then apply calculated usage information by applying usage frequency scores to the attributes, ranking the attributes, filter the set of attributes (e.g., limiting the number to the three most-used attributes), or simply providing the usage measures along with the set of attributes. This information can demonstrate to the AI/ML model 132 that, for example, the attributes “Location” in the sales data table is most often used, and so is most likely the data object to use for interpreting “New York.”

In stage (G), the computer system 110 generates and sends a first request 172 to the AI/ML service provider 130. The first request 172 includes the prompt 170, information about the available data objects in the dataset 122a (e.g., a data model 149 indicating metrics and attributes), and results from the search in stage (F) along with potentially scores or data usage statistics determined for those results. As discussed above, the results of the search that are provided in the first request 172 can be indications of data objects that the computer system 110 identified as relevant to or corresponding to specific terms of the prompt 170. In some cases, the results of the search can be items from a knowledge base 147 or semantic graph 150 that may not specify data objects directly, but which may still provide significant information and context that the AI/ML model 132 can use to interpret the prompt 170 (e.g., to map terms and concepts from the prompt 170 to data objects in the data set 122a).

The first request 172 can be a request for an AI/ML model 132 to generate code or instructions that can obtain, from the data set 122a, result data that would answer the prompt 170. For example, rather than asking the AI/ML model 132 to directly answer to the prompt 170, the first request 172 can request a SQL statement, programming code, a list of operations, or other instructions that specify operations or criteria specifying how to retrieve or calculate and answer to the prompt 170. As a simple example, the prompt to the LLM in the first request 172 may include an instruction such as “provide a SQL statement that retrieves the data needed to answer the question <<user prompt>>,” or “generate Python code that can run on <<database system>> to calculate the answer to the question <<user prompt>>.” The content of the first request 172 can be designed for the particular AI/ML model 132 and its capabilities.

For example, the system 110 can include, as the prompt in the request 172, “Generate a SQL statement that retrieves data from ‘Data Set A’ to answer the question ‘Which regions have the greatest revenue over the last year?’” The request can also include a data model 149 or data schema for “Data Set A,” e.g., for the data set 122a that the chatbot is designed to use in answering questions.

As a result, the first request 172 can be a request for a SQL statement or Python code that, when interpreted or executed by another system such as the database system 120, will cause the other system to retrieve and/or generate a focused subset of data (e.g., a result data set) from the data set 122a that can be used to answer to the prompt 170 from the dataset 122a. The first request 172 can also include one or more custom instructions that the administrator 103 specified, to further guide the AI/ML model 132 to generate data processing instructions that are most applicable for the tasks, situations, purposes, or users that the chatbot is designed for. In some cases, one or more custom instructions are appended or otherwise included with the user prompt 170 in the first request 172.

Many AI/ML models 132, such as LLMs, operate in a substantially stateless manner, in which a general model 132 does not automatically include context of previous interactions or specific knowledge about the chatbot being used. In addition, the chatbots provided by the computer system 110 do not need to have a one-to-one relationship with the AI/ML models 132. For example, a single model 132 may serve as the model for many different customized chatbots that are created and hosted using the computer system 110. Creating and customizing a chatbot does not require training or updating an AI/ML model 132, and instead can define parameters of the chatbot experience that are separate from the AI/ML model 132 (e.g., LLM) itself (e.g., parameters such as the data set used, the custom instructions provided with user prompts, whether Internet data can be used, the format and preferences for answers, and so on).

In order for the AI/ML model 132 to be able to appropriately answer the first request 172 and provide data processing instructions to answer the prompt 170, the computer system 110 can include with the request 172 information about the data set 122a and, in some cases, information about the capabilities of the database system 120. For example, the first request 172 can include metadata about the structure and type of content of the data set 122a, without including actual data of the data set 122a. For example, the metadata may include a database schema, a description of the data objects available from the data set 122a (e.g., logical data objects such as metrics, attributes, facts, etc.), an identification of data set 122a components (e.g., tables, columns, etc.) and a description or classification of semantic meaning of those components, and so on. The request 172 may also include sample data, such as a few rows of data or fictitious computer-synthesized data that is of the same type and structure as the data set 122a, but does not include the actual values from the data set 122a.

For example, the first request 172 can indicate the types of data in the data set 122a, and/or include a sample row or rows of data from the data set 122a, potentially using synthetic data to avoid revealing data of the data set 122a. The request 172 can also include information about the capabilities of the database system 120 and the data processing functions and manipulations that are available. For example, the request 172 can include instructions or description how to interact with the database system 120 to perform various processing functions, such as commands for sorting, filtering, joining, and otherwise manipulating data. In some cases, this information may include text of a user manual or other human-readable text describing the use of the database system 120. As another example, the request 172 can include a table of available commands for manipulating data in the database system 120, an API description for the database system 120, a list of valid interactions and their effects, or other data.

The request 172 can include a data model 149 that includes information about the data set(s) that the chatbot will use to respond to the request 172, without including actual data from the data set. For example, the data model 149 can include a data schema for the data set 122a. In general, the data model 149 can indicate a list of logical objects represented in the data set 122a, such as a list of the elements or components of the data set. For example, the data model 149 can indicate that the data set 122a includes logical objects such as date, customer identifier, region code, sales amount, and so on. These data objects can represent quantities or data objects that are represented in, or can be derived from, data in the data set 122a. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model 149 can indicate the attributes and metrics that are available for the AI/ML model 132 to work with, and potentially additional attributes or metrics that can be generated or operations that are available for the database system 120 to create new attributes or metrics.

In some cases, the data model 149 can indicate, through the logical objects identified, types of data from tables, columns, and other elements that make up the data set 122a, in addition to or instead of the semantic meanings and/or relationships among these elements of the data set 122a. For example, the data model 149 can indicate that the data set 122a includes set of data named “sales_table,” that includes a metric named “sales_amount” that indicates amounts of sales and another attribute named “region” that indicates the region in which the sale occurred. These quantities may or may not correspond directly to the structure of the data set 122a. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set 122a in another way. Providing the data model 149 can give the AI/ML model 132 a list and description of the logical objects that the database system 120 recognizes. As a result, the AI/ML model 132 can generate code or instructions that reference these logical objects that are understood by the computer system 110 and the database system 120. To the extent that the objects indicated in the data model 149 differ from the actual structure of the data set 122a, the computer system 110 and the database system 120 can use convert from the logical object names used in the data model 149 to actual data set elements and functions.

The data model 149 can indicate the names or labels for these data elements, classifications of the elements (e.g., metric, attribute, etc.), and other information. In some implementations, the data model 149 can include sample data for the data set 122a, such as a sampling of data from the data set 122a. The sample data can be fictitious example data that may be artificially synthesized to be representative of the data in the data set 122a (e.g., similar types of data), without indicating actual contents of the data set 122a. The data model 149 can be provided in any of various forms, such as a database schema from a database management system, a list or definitions of objects, components, or identifiers of the data set 122a, etc.

By providing the data model 149 with the request 172, the computer system 110 provides the AI/ML model 132 the ability to make use of the logical objects specified in the data model 149. As a result, the AI/ML model 132 can determine the types of data that would be available from the data set 122a, even without the AI/ML model 132 having any access to the data set 122a. The AI/ML model 132 can generate code or instructions (e.g., a SQL statement) that references these logical objects, with a clear set of names or other identifiers to accurately and unambiguously reference components of the data set 122a. For example, providing the data model 149 for the data set 122a, may enable the AI/ML model 132 to reference logical objects in generated SQL statements that the computer system 110 and/or database system 120 can unambiguously map the logical objects to tables and columns of the data set 122a. This allows the AI/ML model 132 to distinctly and unambiguously define criteria to specify the subset or portion of data to be retrieved from, or calculated based on, the data set 122a.

In addition, access control restrictions can be taken into account to adjust which data can be used. For example, the computer system 110 can generate the request 172 so that the AI/ML model 132 does not use or rely on portions of the data set 122a that the user 132 does not have authorization to access. For example, the data model 149 provided with the request 172 can be a modified version of the data model 149 for the data set 122a that identifies only the logical objects or portions of the data set 122a that the user 105c is authorized to access, and excludes portions of the data set 122a that the user 105c is not authorized to access. As a result, the AI/ML model 132 will not be aware of data sets or data objects that should not be accessed on behalf of the user 105c.

If the chatbot has been configured to use other knowledge assets, such as the one or more knowledge bases 147, the computer system 110 can include some or all of those knowledge assets in the request 172. In some implementations, the knowledge base(s) 147 that have been specified for the chatbot to use are included in their entirety with the first request 172.

In some implementations, as discussed above for stage (F), the computer system 110 can perform or coordinate a selection or retrieval process to identify a subset of the knowledge asset content that is relevant to the prompt 170. For example, the computer system 110 can perform keyword matching to identify portions of a knowledge base 147 that match terms of the prompt 170. As another example, portions of the knowledge bases 147 or other knowledge assets can be selectively retrieved using semantic similarity. For example, the knowledge bases 147 can be entered in a vector database and represented with embeddings or positions in a high-dimensional vector space. The computer system 110 can represent the prompt 170, or separate chunks or portions of the prompt 170, in the vector space and identify the portions of the knowledge bases 147 that are relevant the prompt.

The process of retrieving knowledge base content can be one of multiple retrieval-augmented generation (RAG) retrieval steps. For example, one retrieval or selection step can be used to select content from one or more knowledge assets to be provided to the AI/ML model 132 with the first request 172. As discussed below, the response of the AI/ML model 132 can then be used to retrieve data from the data set 122a (e.g., as done by the database system 120), which can be a second RAG retrieval step.

In addition or as an alternative to providing other knowledge asset content, the computer system 110 can select content from the semantic graph 150 to include with the request 172. The semantic graph 150 represents a source of knowledge that can be applied to a variety of prompts. Generally, the semantic graph 150 is large for an organization and, for any given prompt, the semantic graph 150 includes many elements that are not relevant to the prompt. As a result, the computer system 110 can identify entities and relationships relevant to the prompt 170 as an initial step, and extract information about those entities and the entities they are connected to in the semantic graph 150. For example, the computer system 110 can identify a small sub-network from the semantic graph, as a small knowledge graph of elements related to or connected to terms, entities, or data objects referenced in the user prompt 170. With this information, the computer system 110 can improve its interpretation of both the prompt 170 and the other knowledge assets, such as the knowledge bases 147.

The first request 172 can be generated or adjusted based on information in the long-term memory 148 or other information about the user. For example, given the user interactions or feedback received through prompt-response cycles with the user 105c and/or other users, the long-term memory 148 may include information that can clarify what users intend when they ask a question as indicated in the prompt 170. For example, the long-term memory may specify that a visualization should be included, or that data should be ordered in a particular way. In addition, the computer system 110 also stores information about the user 105c and his current context, represented as user context data 156. This user context data 156 can indicate, for example, the identity of the user, permissions of the user, a device type of the user's device 106c, a location of the user, a role of the user, a department of the user, and so on. In addition, the computer system 110 stores conversation histories 157 of users that have previously interacted with the chatbot. As a result, information about previous prompts from the user 105c and previous responses, in whole or in part (e.g., in summary form) and from the current session and/or previous sessions, can be retrieved and used to supplement the prompt 170. The computer system 110 can provide the user context data 156 and conversation history 157 for the user 105c in or with the request 172, so the AI/ML model 132 can generate data processing instructions with the context of the user's situation and previous conversations, which may better explain or help disambiguate the most recent prompt 170.

In stage (H), the AI/ML service provider 130 uses one or more of the AI/ML models 132 to generate a response to the first request 172. The AI/ML service provider 130 then sends the response, a set of data processing instructions 174, to the computer system 110. As discussed above, the first request 172 requests code or instructions to specify the processing operations that the database system 120 can use to retrieve and/or generate (e.g., calculate) from the dataset 122 the result data that would be needed to answer the user prompt 170. As a result, the AI/ML service provider 130 uses the AI/ML models 132 to generate the data processing instructions 174 that, when executed by the database system 120, will retrieve and/or generate the data needed to answer the prompt 170. In this process, the system 100 leverages the ability of the AI/ML models 132, e.g., LLMs, to generate a set or sequence of instructions or operations. The data processing instructions 174 can be expressed in any of a variety of ways, such as one or more SQL statements, as executable or interpretable code, such as Python code, as a list of API calls or commands to be executed, and so on.

As an example, the data set 122a can include a table named “sales_table,” where the table has an attribute named “region” representing regions and a metric named “sales_amount” that includes the amount of each sale. The data processing instructions 174 generated by the AI/ML model 132 can be a SQL statement such as the one below:

```
SELECT
  region,
  SUM(sales_amount) AS total_sales
FROM
  sales_table
GROUP BY
  region;
```

This example uses an alias “total_sales” for the result of summing sales for each region, to represent the total sales amount for each region after aggregating all the individual sale amounts within each region. The SQL statement here instructs a data processing system to select entries from the table “sales_table” that have the same region identifier value, and create a new “total_sales” value for the sum, resulting in a value of total sales for each different region identifier value.

In stage (I), the computer system 110 uses the received data processing instructions 174 to instruct the database system 120 to obtain (e.g., retrieve, calculate, generate, etc.) the data needed to answer the user prompt 170. For example, the computer system 110 may send a request that includes the data processing instructions 174 to the database system 120, in order to request the needed data. In some implementations, the computer system 110 may apply a set of rules or validation checks to verify that the data processing instructions 174 are valid and appropriate to be executed by the database system 120. For example, the computer system 110 can store rules or heuristics 152 that can evaluate the data processing instructions 174 element by element and/or as a whole to verify and correct the data processing instructions 174 if needed before they are sent to the database system 120. In some implementations, the computer system 110 uses the rules or heuristics 152 to convert or transform the data processing instructions 174 from one format or type to another.

When interacting with the AI/ML service provider 130 and/or the database system 120, the computer system 110 can apply the customized settings and properties that the administrator 103 defined for the chatbot. For example, the administrator 103 can limit which portions of the dataset 122a can be accessed by the chatbot, and so the computer system 110 can apply those limits so that the first request 172 to the AI/ML service provider 130 does not reference omitted data (e.g., excluding from the description of the data set 122a columns or tables that are not to be referenced, so the AI/ML models 132 cannot use them or even determine that they exist). Similarly the first request 172 can include instructions to specifically exclude or avoid using certain data. In addition, or as an alternative, the computer system 110 can filter, edit, or otherwise check the data processing instructions 174 so that the operations specified do not draw from or become calculated based on excluded data. In addition, or as an alternative, the computer system 110 can analyze the results 176 to verify that the results 176 do not include or are not based on the excluded data.

As another example, the computer system 110 can apply access control policies or custom behavior based on the identity or role of the user 105c issuing the prompt 170. Those custom behaviors can be reflected in the interactions of the computer system 110 to the AI/ML service provider 130, such as in the request 172, as well as in the interactions with the database system 120.

In stage (J), the database system 120 generates and sends results 176 that include the data retrieved from and/or generated based on applying the data processing instructions 174 for the dataset 122a. The database system 120 processes or executes the data processing instructions 174 that it receives, which creates the results 176, which may be in any of various forms, such as records retrieved, data series, aggregations of data, statistics about data in the dataset 122a, subsets of the dataset 122a determined to be relevant, and so on.

In the illustrated example, the user prompt 170 asks which regions have the greatest revenue over the last year. The data processing instructions 174 generated by the AI/ML models 132 specify the operations needed to generate measures of revenue by region for the previous year. For example, the data processing instructions 174 may include a SQL statement to retrieve these values, or may include a set of instructions in a programming language, such as Python. The results 176 generated by the database system 120 include the values needed to answer the question in the user prompt 170. In other words, the results 176 include values of revenue for the regions specified in the dataset 122a, appropriately labeled or associated with identifiers for those regions. In this process, the AI/ML models 132 have been leveraged to obtain the results 176, however, the AI/ML models 132 did not need or receive access to the dataset 122a itself, and the AI/ML models 132 did not incur the resource costs of having to process the dataset 122a. In addition, the database system 120 and its reliable, repeatable calculations ensure that the results 176 are accurate, without the AI/ML models 132 introducing uncertainty into the calculations.

In addition, the dataset 122a may be very large, much larger than the maximum context length of an LLM used for the AI/ML model 132. In many cases, the amount of data in the dataset 122a may be orders of magnitude larger than the maximum context size that the LLM can process. The database system 120 can process a large dataset much more quickly and with greater power efficiency than an LLM can. Due to limits on LLM context sizes, it may be impractical or impossible for an LLM to analyze the dataset 122a to generate the needed results 176.

In stage (K), the computer system 110 sends a second request 178 to the AI/ML service provider 130. The second request 178 includes the results 176 and requests that the AI/ML models 132 generate a summary or other text response that answers the prompt 170 based on the results 176. For example, the second request 178 may be a request to answer the prompt 170 using the data in the results 176 as context. As another example, the second request 178 may be a request for the AI/ML models 132 to summarize the results 176, in addition to or instead of answering the user prompt 170. The second request 178 can also include one or more custom instructions that the administrator 103 specified, to further orient the AI/ML model 132 to respond in the format and with the content that is most applicable for the dataset 122a and/or the overall purpose for which the chatbot was designed (e.g., customization for a particular organization, set of users or user roles, set of tasks, etc.). In some cases, one or more custom instructions are appended or otherwise included with the user prompt 170 in the second request 178.

As with the first request 172, the computer system 110 can provide the user context data 156 and conversation history 157 for the user 105c in or with the second request 178, so the AI/ML model 132 can generate a response based on the context of the user's situation and the user's previous conversations, which may better explain or help disambiguate the most recent prompt 170. The computer system 110 can also provide information from the long-term memory 148 that the computer system 110 determines to be relevant, potentially as determined to be relevant specifically to the user 105c, the user context data 156, and/or the prompt 170.

In some implementations, the chatbot is configured to generate visualizations as part of the response to a user prompt 170. To create these visualizations, the computer system 110 can include in the second request 178, or as an additional request, a request for the AI/ML models 132 to indicate an appropriate type and format of visualization for the response to the request 178. The AI/ML models 132 can then be used to specify the parameters for the visualization, such as the type of visualization (e.g., line chart, bar chart, line graph, geographical map, heat map, etc.), and identification of which data items are shown on different axes or dimensions of the visualization, the ranges to show, the labels to use, the color scheme, and or other properties.

In stage (L), the AI/ML service provider 130 uses the AI/ML models 132 to generate a response to the user prompt 170, e.g., a summary 180 of the results 176 or other response requested by the second request 178. For example, the second request 178 may include or provide access to the results 176 and the user prompt 170, and so the AI/ML models 132 answer the prompt 170 from the context provided by the results 176. In some implementations, this may be a summary of the results 176 and/or may include values extracted from the results 176 with added text description generated by the AI/ML models 132.

For example, in the illustrated example, the AI/ML models 132 indicate the specific regions having the greatest revenue, as requested by the prompt 170, along with an indication of the revenue values taken from the results 176, along with other description and contacts. If the request 178 requests information about a visualization, or if the AI/ML models 132 determine that a visualization is likely appropriate or beneficial, then the summary 180 can include a visualization description. The visualization description can specify the properties recommended for a visualization of the results 176 as a whole, or for specific items that answer the user prompt 170.

In stage (M), the computer system processes the summary 180, and generates and sends a response 182 as the answer of the chatbot to the user prompt 170. The response 182 is then displayed on the user interface 162 of the client device 106c. The computer system 110 can process the summary 180 to create the response 182, for example, by applying customized settings or policies specified in the saved chatbot configuration data 146. In this way, the computer system 110 can apply customized style, formatting, content preferences or restrictions, and other customizations that were defined by the administrator 103. In addition, or as an alternative, the computer system 110 can incorporate those customizations when making the request 178. For example, the computer system 110 may include in the request 178 preferences for a concise or verbose answer, the tone or style of text used, and other preferences.

When a visualization is requested by the prompt 170 or suggested by the AI/ML models 132, the computer system 110 uses the visualization description from the AI/ML models 132 to generate the actual visualization content. In this manner, the visualization that is provided is based on reliable, accurate data or calculations in the results 176 and/or the dataset 122a. For example, the visualization that is rendered has the type of data specified by the AI/ML model 132, and in the arrangement specified by the AI/ML models 132, but with values or data series shown being determined through data retrieval and/or calculations of the database system 120 to ensure accuracy and reliability.

Through any and all of the interactions of the computer system 110 to generate and provide the response 182, the computer system 110 applies the settings and properties specified in the saved chatbot configuration data 146. As a result, the behavior and characteristics that the administrator 103 specified for the chatbot can be enforced at any or all stages of the process to provide the customized interface and chatbot behavior that the administrator 103 desired.

In some implementations, the computer system 110 generates visualization data for a visualization 183 of the results 176 obtained for answering the user prompt 170. The computer system can examine the data processing instructions 174 from the AI/ML model 132 to determine characteristics of the visualization to be created. For example, software of the computer system 110 can examine the data processing instructions 174 to identify data objects, relationships, and other aspects that can be mapped to features of a visualization. The computer system 110 can specify the characteristics of the visualization in a visualization specification, as those characteristics are extracted from or inferred based on the data processing instructions 174. The characteristics can indicate any of various features to be shown (e.g., data objects to be retrieved or calculated, visualization type, which data series to be illustrated, independent or dependent variables, data ranges, labels for visualization components, and so on).

In some implementations, although the results 176 are already obtained, the visualization specification includes sufficient information for a data processing system, such as the database system 120, to retrieve and calculate all of the data needed to create a visualization or to refresh the visualization with updated information from the data set 122a. In some cases this includes indicating when new logical objects or new quantities need to be defined. For example, if a visualization would use a new column of data that is not natively stored in the data set 122a but is calculated based on columns of data in the data set 122a, the visualization specification can define this column and specify the operations or expressions used to calculated it. For example, if a visualization involves a “profit” metric not stored in the data set 122a, the visualization specification can define the “profit” value to be a “sales” value minus a “cost” value, where the “sales” and “cost” are values (e.g., attributes or metrics) that are part of the data set 122a. As a result, using the visualization specification, the database system 120 would be able to identify the types of data that need to be retrieved and/or calculated and generate those values for the visualization.

For example, the computer system 110 can examine the SQL statement that the AI/ML model 132 provided as the data processing instructions 174 to identify data that is retrieved or calculated. The significance of the different types of data referenced can be inferred from the clauses, commands, or operators used in the data processing instructions 174. For example, in the example discussed above, the computer system 110 can identify the calculation result for revenue, such as the “total_sales” values in the SQL statement discussed above, as a dependent variable to be illustrated, based on its position following the command “AS” and based on the value being calculated as a result of the “SUM( )” function. The computer system 110 can similarly identify “region” as an independent variable based on its use in the “GROUP BY” clause.

Based on the information extracted from the data processing instructions 174, and the data model 149 describing the semantic meanings, data types, and/or relationships of these data objects in the data set 122a, the computer system 110 can select a visualization type, e.g., line graph, bar chart, pie chart, heat map, geographical map, etc. The selection can be based on any of multiple factors, including the number of attributes and metrics referred to (e.g., where some visualization types are better suited for larger numbers of data objects), the number of data series (e.g., line charts can show multiple data series, while a pie chart is better suited for a single group of values), relationships of the data objects (e.g., with line charts and bar charts showing relationships with respect to time better than geographical maps, which show relationships with respect to locations), the semantic meanings of the data objects (e.g., a geographical map being more likely when a city, state, country, or other geographical independent variable is present), and so on.

In this case, the computer system 110 selects a pie chart as an appropriate visualization type. Other types of visualizations could similarly be selected (e.g., bar chart, geographic map, etc.) Because the calculation result is values of “total_sales,” those values are designated to set the relative sizes of the different slices of the pie chart. The values of “total_sales” and “region” in the SQL statement are selected as labels for the slices, so each slice indicates the region identifier and the amount of total sales. The visualization specification includes the various characteristics, parameter values, and relationships determined from analysis of the data processing instructions 174. For example, the visualization specification can indicate a pie chart as the type of visualization, the “total_sales” as the quantity defining the pie chart slices, the “total_sales” and “region” values as labels for the pie chart slices, and so on. The visualization specification can also specify other properties that may be selected based on factors or sources other than the content of the data processing instructions 174. For example, the computer system 110 can store templates that specify visual properties for layout, formatting, font, size, color, and so on. The style template or visual style used can be selected based on user preferences, a selection for the company or other organization, a style of the current document or project in the user interface 162, a default style, and so on. These visual properties can be included in the visualization specification or the visualization specification can include an identifier or reference (e.g., URL) to a source of style information (e.g., a style template document, a cascading style sheet, etc.).

The computer system 110 combines the retrieved data in the results 176 from the database system 120 with the visualization characteristics specified in the visualization specification to generate visualization data that can be rendered or displayed by the user device 106c. The computer system 110 can use a visualization generator module to create the visualization data, such as image data, markup language content (e.g., HTML, XML, etc.), or other data that can be rendered or displayed to provide the visualization. For example, from the results 176, the visualization generator can obtain values for “total_sales” for each of multiple regions. Based on the visualization specification, the computer system 110 determines that the values should be indicated in a pie chart, and the computer system 110 generates the pie chart with layout, style, formatting, and other properties as specified in the visualization specifications.

As an example of content of the knowledge bases 147, the knowledge bases 147 can include descriptions and definitions for an organization. Users can upload this content as text, as entries in a spreadsheet file, or in other forms. For example, a knowledge base 147 can include one statement that “ESS stands for Employee Satisfaction Score,” and another statement that “ESS score of rating 4 and below means the employee is not satisfied or needs attention.” A chatbot that receives question about employees, or which access a data set about employees, can be configured to process the knowledge base content as context for an LLM (e.g., provided with a prompt as input to the LLM), so that the information in the knowledge base 147 is present when the LLM processes user prompts. In this manner, knowledge bases 147 and other knowledge assets can instill a form of long-term memory or persistent memory to allow more meaningful interactions with users. The knowledge assets can bridge the knowledge gap between users and AI/ML models 132 by providing the AI/ML model with a deeper understanding of general knowledge, simulating long-term memory. This can be done using retrieval-augmented generation (RAG), to retrieve some or all of a knowledge asset to use as context for an AI/ML model 132.

Administrators can upload knowledge assets like business glossaries, industry terminology, and relevant definitions to allow chatbot responses tailored for an organization and its specific terminology. The content can be provided in the form of a spreadsheet, text document, or other form. In many cases, knowledge assets can focus on information that directly supports typical inquiries, and can steer clear of including general rules or overly broad concepts that may be vague or difficult to apply.

Continuing the example of knowledge base content, a user can enter a user prompt, “How many employees need attention?” If a chatbot did not have the knowledge base 147 that explains the appropriate definitions, standards, or criteria, the chatbot (including the AI/ML model 132 used) would not be able to interpret the what “need attention” means in the user prompt. Without the knowledge base content, the chatbot in this example would be unable to formulate an effective set of code or instructions (e.g., a SQL statement) for data processing (e.g., the AI/ML model 132 would be unable to identify the logical data objects or components of the data set that are relevant to the question). If the retrieval stage of retrieving data from the database system 120 was ineffective, and so the second stage of interaction to answer the user's question would also be ineffective.

On the other hand, when the knowledge base content is available, the chatbot can use the definitions, descriptions, standards, or criteria and apply them to interpret and answer the user's prompt. For example, when the user prompt asks how many employees need attention, the knowledge base content includes the statement that provides the criteria for judging whether an employee needs attention, e.g., a ESS score of four or less needs attention. The knowledge base content also includes the statement that provides the meaning of the abbreviation “ESS.” With these pieces of information provided as context to the AI/ML model 132, the AI/ML model 132 can identify the logical data objects of the data set that can provide the ESS score. The knowledge base content can be provided to the AI/ML model 132 initially, such as upon initialization of a communication session with the chatbot. As another example, the knowledge base content can be provided as input to the AI/ML model 132 with the user's prompt. In some implementations, the computer system 110 searches through one or more knowledge bases 147 to find entries or portions of knowledge base content that are relevant to the keywords and/or concepts in a user's prompt, and the computer system 110 provides the relevant subset of knowledge base content with the user prompt. As a result, this can be a RAG retrieval step that supplements the user prompt with knowledge base information in the first request 172.

The information in the knowledge base content can thus provide the links or connections needed for the AI/ML model 132 to reference the data object (from among data objects specified by a data model 149 also provided to the AI/ML model 132) that represents the ESS score, and which can be used to retrieve data from the ESS score column of a table in the appropriate data set. Then, because the appropriate logical data object is referenced, the data processing instructions (e.g., SQL statement, Python code, etc.) that the AI/ML model 132 generates in the first round of interaction to answer the prompt includes valid references to the type of data needed to answer the prompt (e.g., ESS scores). Because this link to the proper data object in the data set is provided, the database system 120 provides the needed data, such as the identifiers and scores for users having a ESS score of four or less, and the AI/ML model 132 can use that retrieved data to generate and provide the information in the response.

In some implementations, the chatbot can provide information that indicates the interpretation that the AI/ML model made for terms or concepts in a user prompt. For example, the computer system 110 can provide information, for display in the chatbot interface 162, that indicates the mapping of terms or concepts to particular data objects in a data set (e.g., metrics, attributes, data columns, etc.) and/or to the semantic meaning or a text description of the type of data represented by those data objects.

For example, the interpretation content can include a natural language summary that states that the prompt “How many employees need attention?” was interpreted as “Count the number of employees needing attention with a ESS score of 4 or less.” This interpretation demonstrates how the chatbot was able to incorporate the meaning or definition of what it means to “need attention” from the statement in the knowledge base content. By displaying the interpretation content, the user interface also shows the user the definition used.

In addition, the interpretation content can specify the data objects or data set components used in generating the data used to answer the prompt. For example, the interpretation can show that an attribute “ID” was used, which represents an employee identifier. Also, a new metric can be specified as “employees needing attention” which attempts to count distinct employees, and that a filter criterion or selection criterion of “ESS<=4” is applied. As a result, the interpretation content can show how the chatbot used the “ID” attribute, and then found distinct “ID” values associated with a ESS score of four or less to arrive at the answer presented in the chatbot response.

In some implementations, the interpretation content is obtained by analyzing or processing the data processing instructions that the AI/ML model 132 produces. For example, the response to the first request to the AI/ML model 132 for generating data processing instructions can be a SQL statement that specifies data to retrieve, such as to retrieve the set of employee IDs having ESS scores of 4 or less. From the SQL statement, the computer system 110 can identify or extract the data objects referenced, e.g., the metrics, attributes, as well as operations or other instructions, e.g., expressions or equations, filter criteria, sorting criteria, etc. That information can then be provided as the set of components used. In addition, the computer system 110 can send the data processing instructions that the AI/ML model 132 created back to the AI/ML model 132, along with an instruction to provide a concise natural language statement summary. In other words, the computer system 110 can request for the AI/ML model 132 to convert or translate the SQL statement into an actual language summary, which can then be provided in the interpretation content.

FIGS. 2A and 2B show examples of chatbot interfaces. FIG. 2A shows an example in which an initial search for terms in the prompt 202 was not performed, and so the AI/ML model 132 did not receive results that could assist in interpreting the prompt 202. As a result, the chatbot response 204a is unable to provide the information requested in the prompt 202. FIG. 2B shows another example in which a search for terms in the prompt 202 is performed, and results are provided to the AI/ML model 132. With the search results, the AI/ML model 132 has the additional information needed to link the terms of the query 202 to the appropriate data (e.g., data objects, records, criteria, etc.) in the data set, and so the chatbot response 204b correctly answers the prompt 202 by providing the information requested.

In further detail, FIG. 2A shows a chatbot interface 200a, in which the user has submitted the prompt 202 “GDC HC for Unit Owner reza viratsehs.” This prompt 202 or query includes several terms that need to be interpreted (e.g., references that need to be resolved properly) in order to answer the prompt 202. For example, “GDC HC” refers to a particular type of metric, such as a score, count, or other measure. In addition, “Unit Owner” refers to an attribute, in this case a particular column of data in a data set specifying names of owners. The name “reza viratsehs” is specified by the user, but the name is not included in the set of values in the “Unit Owner” attribute. As a result, the chatbot is unable to find the requested information and provides the response 204a “I'm sorry, but the name ‘reza viratsehs’ is not found in the ‘Unit Owner’ attribute. We have valid elements like ‘Zhiheng Mai’, Matthew Zingaro’, ‘Richard Regan’, ‘Ignacio Suarez’, ‘Aaron Nye’ and others.”

There may be various reasons that the user specifies a name or other entity which the chatbot cannot identify or use. For example, the name may be misspelled, abbreviated, include a nickname or synonym, or otherwise not match the values for an attribute. In some cases, even providing a name in lower case may not meet strict matching standards with a capitalized name, and so may not be recognized. In some cases, the name may be correct, but the user may specify an incorrect attribute, so that the specified attribute does not have a match, but a different attribute of the records would have the desired match. In some cases, the user may not indicate an appropriate attribute at all, and so without the benefit of an initial search the chatbot may not be able to determine which of many different attributes is relevant for a term.

In FIG. 2B, after receiving the same prompt 202, “GDC HC for Unit Owner reza viratsehs,” the chatbot benefits from results of a search for the term “reza viratsehs” to answer the prompt 202. In particular, the computer system 110 uses the search index 153 to find instances of the term “reza viratsehs” and similar terms and concepts. Beyond searching for exact text matches, the computer system 110 can identify partial matches and semantically related terms and synonyms. The computer system 110 then provides the results of that search with the prompt 202 to the AI/ML model 132, with the first request to generate data processing code or instructions (e.g., a SQL statement). With the information from the search, the AI/ML model 132 is able to accurately specify the data processing criteria for finding the requested answer. For example, the AI/ML model 132 is able to generate a SQL statement that accurately maps the terms and concepts of the prompt 202 to the attributes and metrics of the appropriate data set, and also specify the filters, selection criteria, and other data processing operations to retrieve or generate the answer requested. After the generated code and instructions are processed by the database system 120, the result data having retrieved values from the data set is provided to the AI/ML model 132 with the instruction to generate a response 204b to the prompt 202. The result data specifies the answer of “3” for the “GDC HC” value, and so the user receives the answer that was desired.

In this example, the term “reza viratsehs” still does not occur as a value of the “Unit Owner” attribute. However, because of the search using the search index 153, the computer system 110 is able to find a record that corresponds to the term. For example, “reza viratsehs” may be a variation of a longer name (such as an official name with a middle name or middle initial) that is present in the “Unit Owner” attribute and can be found using a semantic search or vector database search even though not an exactg match. The search by the computer system 110 can identify and provide a search result that indicates the similar name or another identifier for that record, allowing the AI/ML model 132 to specify data processing code or instructions in a way that aligns more closely with the data set contents.

As another example, the name “reza viratsehs” may be a synonym or alias for a different valid entry in the “Unit Owner” attribute. The semantic graph 150 or the knowledge base 147 may include information that specifies the correspondence between the user's term and the synonym term that is more standardized and is included as a value in the “Unit Owner” attribute. As a result, the initial search by the computer system, whether using the search index 153 or by searching the semantic graph 150 or the knowledge base 147 directly, can identify the information that specifies this relationship. The computer system 110 can provide to the AI/ML model 132 the statement or information that specifies the synonym relationship, or can specify the identified value that is relevant to or can be equated to the term the user provided. As a result, the AI/ML model 132 can make the connection between the user-provided term and the corresponding term or value that can be used to identify the correct record. The AI/ML model 132 can then generate the data processing code or instructions to select or filter data using the term indicated using the synonym relationship, so the data processing code or instructions can be effectively processed by the database system 120 and yield the desired answer.

As another example, the user that submitted the prompt 202 may have made a mistake in naming the “Unit Owner” attribute, mistaking Reza Viratsehs to be the owner when instead he is the manager, and so the question should have listed the “Manager” attribute instead of the “Unit Owner” attribute. In this case, the search index 153 can indicate that the term “reza viratsehs” (or at least a capitalized or similar version of the name) occurs in the “Manager” attribute of the data set (e.g., a data table column listing manager names). As a result, the computer system 110 sends the search results showing that “reza viratsehs” is a value in the “Manager” attribute. When the AI/ML model 132 interprets the prompt 202 and generates data processing code and instructions, the resulting SQL statement can state that the results are filtered to the name “Reza Viratseh” as the value of the “Manager” attribute. This, in turn, allows the database system 120 to retrieve the correct value of “3,” because the SQL statement filters to the value of the “Manager” attribute (where the user's stated value of “reza viratsehs” exists) and not to the “Unit Owner” attribute (where the user's stated value does not exist).

In general, the search capability of the computer system 110, including the search index 153 and potentially vector database searching, enable the computer system 110 to find instances or links among data sets and metadata that would not otherwise be found or be available to an AI/ML model 132 when answering a user prompt. When the user's term may be found in a column other than the “Unit Owner Name,” such as business name, nickname, preferred name, etc., performing the search across a wider set of data objects (e.g., beyond the specified “Unit Owner” attribute alone) can find a connection or link to the value the user provides. Instances that are found as results, even if partial matches or have related meanings, can be records that provide a more appropriate or more standardized version of a term. In the example of FIG. 2B, search results can identify records that show the official “Unit Owner” name and allow the user's intended reference to be correctly resolved, despite the mismatch between the user's terms and/or the user potentially incorrectly identifying the data object type “Unit Owner.” The values identified from results of the search can then be used for filtering or selecting data used to answer the user prompt.

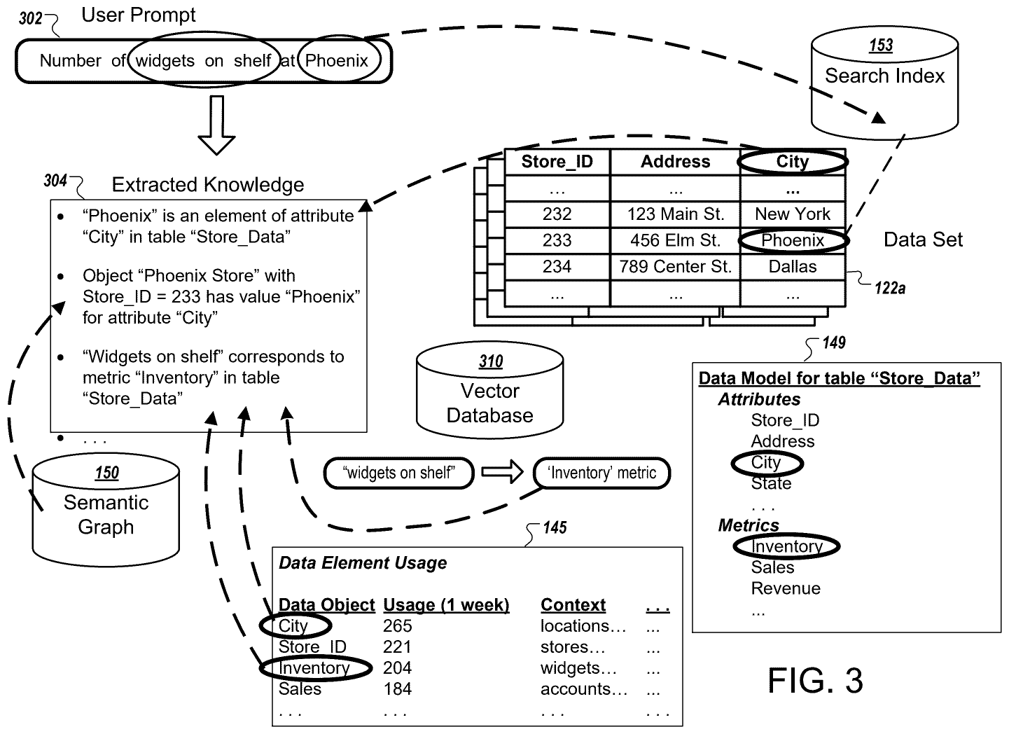

FIG. 3 shows an example of data processing for a chatbot, where search capabilities improve the interpretation of a user prompt by a chatbot and the generation of a response to the user prompt.

In the example, a user submits a user prompt 302 to a chatbot, where the prompt text is “Number of widgets on shelf at Phoenix.” The user prompt 302 includes references such as “widgets on shelf” and “Phoenix” that may have multiple interpretations, or the intended interpretations may not be clear from the prompt 302 and conversation history.

When the computer system 110 receives the user prompt 302, the computer system can perform searching to identify relevant records, data objects, and interpretations before sending a request to an AI/ML model 132. As discussed above, the computer system 110 can have a search index 153 that indicates instances of terms or other data in the data set 122a that the chatbot is configured to use. In this example, the computer system 110 uses the search index 153 to search for the term “Phoenix.” The search returns a result that the term “Phoenix” is a value in a column labeled “City” in a data table of the data set 122a.

This search result provides a variety of useful information that will help the AI/ML model 132 interpret the user prompt 302. For example, the occurrence of the term “Phoenix” in the “City” column signals that the user is interested in the type of data in the “City” column and that this is an appropriate attribute for filtering the data to identify the answer for the user. In other words, finding an instance of the value the user provided connects a portion of the user prompt 302 (e.g., “Phoenix”) to a particular data object (e.g., the “City” column or attribute), which the AI/ML model 132 can then use for selecting, filtering, aggregating, or otherwise processing data to answer the user prompt 302.

The computer system 110, having found an instance of the term “Phoenix” through the search, generates a representation of this search result to be provided to the AI/ML model 132. In the example, this takes the form of extracted knowledge 304 that will be provided to the AI/ML model 132 with the user prompt 302 as additional context for processing or interpreting the user prompt 302. Here, the search result is expressed as a statement “Phoenix” is an element of attribute ‘City’ in table Store_Data.” The AI/ML model 132 receives information from the data model 149 for the data set 122a, and so this statement specifies data objects from the data set 122a (e.g., a specific table and attribute) that the AI/ML model 132 will be able to refer to and use to generate data processing code and instructions. From the extracted knowledge 304, the AI/ML model 132 now will have a clear indication to use the “City” attribute and map the term “Phoenix” to be a value for that attribute.

As discussed above, the AI/ML model 132 does not have access to the data set 122a or to the search index 153, which preserves the privacy of the data. The AI/ML model 132 receives result data that the database system 120 generates (such as results 176 in FIG. 1B), but does not have full access to the underlying data set 122a. As a result, the AI/ML model 132 would not have the access or opportunity to find these connections between the user prompt 302 and the data in the data set 122a. In addition, in many cases, AI/ML models 132 would not have the capability or reason to find or use these connections for interpreting the user prompt 302, even if the AI/ML model 132 did have access to the data set 122a or the search index 153.

The identified search result also provides additional information that is important for answering the user prompt 302. In the example, the user does not intend to ask about the city of Phoenix as a whole, but rather a particular store located in Phoenix. The search result finding a record with an attribute of phoenix also has a “Store_ID” value that identifies the corresponding store. The computer system can use the search index 153 and/or the data set 122a to identify the value of “Store_ID,” e.g., 233, that corresponds to the search result. As another option, the computer system can use the semantic graph 150 to identify a related object of the semantic graph that is related to the user's term. For example, the computer system 110 can search the semantic graph 150 to find relevant objects (e.g., nodes in the semantic graph), and in this case, identifies an object “Phoenix Store” as relevant. The semantic graph data for the “Phoenix Store” object indicates that the “Store_ID” for the store is 233. From the search results, the computer system 110 can include in the extracted knowledge 304 a representation of the relationships identified, e.g., “Object ‘Phoenix Store’ with Store_ID=233 has value ‘Phoenix’ for attribute ‘City.’” This information identifies the attribute “Store_ID” for the AI/ML model 132 and provides the value that corresponds to the user's term, “Phoenix,” enabling the AI/ML model 132 to filter data according to the appropriate store identifier, even though it is not specified by the user prompt 302 or other context.

The computer system 110 can also use a vector database 310 to identify items that are related in meaning or concept to terms in the user prompt 302. For example, the computer system 110 can search for the phrase “widgets on shelf,” and the search using the vector database 310 can provide an indication of relevant data objects or other content. For example, the vector database 310 can include vector representations of attributes, metrics, column labels, data object descriptions, and so on. As a result, a search for “widgets on shelf” returns a result that an “Inventory” metric is closely related. Because the searching can use a semantic search or search by concept rather than text match, the computer system 110 is able to obtain the appropriate data object even though the user provided a different term. The computer system 110 updates the extracted knowledge 304 to show this relationship, stating “‘Widgets on shelf’ corresponds to metric ‘Inventory’ in table ‘Store_Data.’” This will provide the AI/ML model 132 an indication that the user is requesting data about the “Inventory” metric, allowing the AI/ML model 132 to use this mapping from the user prompt 302 to the metric to generate data processing code or instructions.

The computer system 110 can also use data element usage records 145 to add to or complement the extracted knowledge 304. For example, having identified the “City” attribute as corresponding to the term “Phoenix” and the “Inventory” metric corresponding to the term “widgets on shelf,” the computer system 110 can look up the usage statistics for those data objects. The computer system 110 can include the usage information in the extracted knowledge to provide to the AI/ML model 132. In some cases, the computer system 110 can generate scores for the various data objects identified as relevant, based on the usage rates, and those scores can be provided in the extracted knowledge 304 or used by the computer system 110 to determine which of multiple possible terms is most appropriate (e.g., to filter a set of multiple potential data objects). For example, if there are multiple attributes or metrics that each have a users term as a value, then the most frequently used data object may be the best fit.

As another example, the data element usage records 145 can indicate context information that specifies related terms, topics, data sets, data objects, and so on that most commonly occur with a given data object. By comparing the different contexts in which data object have been used with the terms in the user prompts 302 and the conversation context (as well as a set of data objects that have been determined to be relevant to the prompt 302), the computer system 110 may determine that one data object is a better fit than another. For example, the context information may show that a particular data object is the most appropriate or most likely mapping for a term due to co occurrence of contextual elements, even if that particular data object is not the most commonly used among the options found.

In some implementations, the computer system 110 uses the data model 149 for the data set that the chatbot can access to generate the extracted knowledge 304. For example, the computer system 110 can use the data model 149 to identify specific data objects and identifiers for those data objects that correspond to results identified through searching.

After the searching is performed and the computer system 110 has generated the extracted knowledge 304, the computer system 110 can provide the user prompt 302 and the extracted knowledge 304 to the AI/ML model 132 in a request. As discussed for the request 172 in FIG. 1B, the request can be for the model 132 to generate data processing code or instructions. The information in the extracted knowledge 304, which identifies data objects that are relevant to the terms of the user prompt 302, can greatly increase the likelihood that the AI/ML model 132 makes a correct mapping of terms to data objects. This, in turn, results in higher quality data processing code or instructions, and ultimately higher quality result data from the data processing system 120, so the chatbot response is more likely to answer the user prompt 302 with the information the user desires.

In some implementations, the extracted knowledge 304 that is generated for and provided with each user prompt can serves as a customized knowledge base specifically tailored for the particular prompt being processed. The searching and corresponding generation of extracted knowledge can be performed for each prompt separately, to gather for each user prompt the relevant items and connections identified from one or more of sources (e.g., the search index 153, the applicable data sets 122a-122n, the semantic graph 150, the vector database 310). This is particularly valuable when the one or more sources are not otherwise available to the AI/ML model 132, whether for privacy or security reasons, due to limitations on the context size allowed for the AI/ML model 132, or for other reasons.

Although the extracted knowledge 304 is illustrated as text in the example, the identification of data objects and the relationships identified can be expressed in many forms, including enlists, structured data, embeddings, and so on, and need not be in a text format or human-readable format.

As discussed above, the computer system 110 can includes infrastructure that automatically pinpoints and indexes the most frequently utilized attributes or attribute forms within datasets, particularly those heavily used by AI/ML features like chatbots. The search index 153 can enhance the AI/ML services by adeptly searching for elements in the applicable data sets 122a-122n that are similar or conceptually closest to the terms in the user's question. The system can trigger the indexing of a data set based on any of various factors, including a change in the data set 122a-122n, based on a high rate of use of particular data objects, and other factors.

These features can the intrinsic ability of chatbots to effectively handle queries with inaccurately named elements, ambiguous attributes, or typographical errors. The search can leveraging semantic search technologies like Azure AI search index or ElasticSearch. This can empower the computer system 110 to accurately interpret and process queries, even when they contain incomplete, misspelled, or abbreviated terms. This can refine the capacity to identify and fetch relevant elements from datasets to deliver more accurate, contextually appropriate, and reliable responses, thereby substantially improving the user experience.

The techniques provide a number of benefits. One is enhanced element name recognition, allowing the system to effectively identify correct data objects or values, even in instances of misspellings or variations. Another benefit is improved contextual and semantic attribute identification. For example, if a user asks, “How much sales did John Murphy generate?”, it may be unclear if the user is asking about John Murphy the employee or the customer, if there are two different people with the same name (or two different profiles for different roles of the same person). The search capability can accurately assess and filter information to provide the correct result. Another benefit is support for synonyms and abbreviations, such as by ensuring that terms with similar meanings (e.g., ‘cats’ and ‘kittens’, ‘sales’ and ‘revenue’) and abbreviations (e.g., ‘NY’ for ‘New York’) yield consistent and relevant results.

These features provide benefits in a variety of use cases. For example, the system can perform well for attribute-agnostic queries. For example, if a user asks, “What amount of sales did John Murphy generate?”, the system can find the right information, and feed into the learning infrastructure. Plus, the system understands and links synonyms, so ‘sales’ and ‘revenue’ both return relevant results. With semantic searching, the system intelligently searches for elements related to the name mentioned in the query and provides accurate results. Another beneficial use case is resolving misspelled element names. A data element can be a value or piece of data in a data set, or may refer to a type of data or data object as a whole. In a scenario where a user accidentally misspells an element's name in their query, the system can leverage cognitive search or semantic search to identify the intended data element. For example, if the user types “Reza Viresta” instead of “Reza Virasteh,” the feature will recognize the similarity and return relevant results. in addition, the features are beneficial for synonym resolution. Users may use different terms for the same data element. For instance, one person might refer to “sales” while another uses “revenue,” while both are referring to the same metric. This feature can map synonyms and ensure that queries using different terminology still yield meaningful results.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method performed by one or more computers, wherein the method comprises:
storing, by the one or more computers, a search index for data sets, wherein the search index describes data objects of the data sets and values for the data objects in the data sets;
receiving, by the one or more computers, a user prompt to a chatbot;
in response to receiving the user prompt, searching, by the one or more computers, for data objects and values that are relevant to the user prompt, including using the search index to search for data objects and values of one or more data sets that the chatbot is configured to access;
using, by the one or more computers, one or more results obtained using the search index to generate a chatbot response to the user prompt, including providing the one or more results to an artificial intelligence and/or machine learning (AI/ML) model; and
providing, by the one or more computers, the chatbot response as a response to the user prompt.

2. The method of claim 1, wherein the one or more results obtained using the search index comprise data objects corresponding to terms of the user prompt.

3. The method of claim 1, wherein the one or more results obtained using the search index comprise values corresponding to terms of the user prompt.

4. The method of claim 1, wherein the search index includes information determined based on structure and metadata of a data set, including at least one of data table names, data table labels, data table descriptions, column names, column labels, or column descriptions.

5. The method of claim 1, wherein the searching comprises identifying elements that are likely to identify or disambiguate references to attributes, metrics, and other data objects referenced in the user prompt.

6. The method of claim 1, wherein the one or more results are provided to the AI/ML model such that the one or more results are used by the AI/ML model to determine data objects corresponding to terms or concepts in the user prompt.

7. The method of claim 1, wherein the one or more results comprise information that specifies relationships between terms of the user prompt and data objects, such as data indicating the data objects identified as being most closely related to particular words or phrases of the user prompt.

8. The method of claim 1, wherein the searching comprises searching for similarity using a vector database, including by comparing the distance of embeddings for terms or concepts of the user prompt with stored embeddings.

9. The method of claim 1, comprising using the search index to identify which data set or data sets, from among multiple data sets, should be used to generate an answer to the user prompt.

10. The method of claim 1, wherein the one or more results include at least one of semantic graph content or knowledge base content.

11. A system comprising:
one or more computers; and
one or more computer-readable media storing instructions that are operable, when executed by the one or more computers, to cause the system to perform operations comprising:
storing, by the one or more computers, a search index for data sets, wherein the search index describes data objects of the data sets and values for the data objects in the data sets;
receiving, by the one or more computers, a user prompt to a chatbot;
in response to receiving the user prompt, searching, by the one or more computers, for data objects and values that are relevant to the user prompt, including using the search index to search for data objects and values of one or more data sets that the chatbot is configured to access;
using, by the one or more computers, one or more results obtained using the search index to generate a chatbot response to the user prompt, including providing the one or more results to an artificial intelligence and/or machine learning (AI/ML) model; and
providing, by the one or more computers, the chatbot response as a response to the user prompt.

12. The system of claim 11, wherein the one or more results obtained using the search index comprise data objects corresponding to terms of the user prompt.

13. The system of claim 11, wherein the one or more results obtained using the search index comprise values corresponding to terms of the user prompt.

14. The system of claim 11, wherein the search index includes information determined based on structure and metadata of a data set, including at least one of data table names, data table labels, data table descriptions, column names, column labels, or column descriptions.

15. The system of claim 11, wherein the searching comprises identifying elements that are likely to identify or disambiguate references to attributes, metrics, and other data objects referenced in the user prompt.

16. One or more non-transitory computer-readable media storing instructions that are operable, when executed by one or more computers, to cause the one or more computers to perform operations comprising:
storing, by the one or more computers, a search index for data sets, wherein the search index describes data objects of the data sets and values for the data objects in the data sets;
receiving, by the one or more computers, a user prompt to a chatbot;
in response to receiving the user prompt, searching, by the one or more computers, for data objects and values that are relevant to the user prompt, including using the search index to search for data objects and values of one or more data sets that the chatbot is configured to access;
using, by the one or more computers, one or more results obtained using the search index to generate a chatbot response to the user prompt, including providing the one or more results to an artificial intelligence and/or machine learning (AI/ML) model; and
providing, by the one or more computers, the chatbot response as a response to the user prompt.

17. The one or more non-transitory computer-readable media of claim 16, wherein the one or more results obtained using the search index comprise data objects corresponding to terms of the user prompt.

18. The one or more non-transitory computer-readable media of claim 16, wherein the one or more results obtained using the search index comprise values corresponding to terms of the user prompt.

19. The one or more non-transitory computer-readable media of claim 16, wherein the search index includes information determined based on structure and metadata of a data set, including at least one of data table names, data table labels, data table descriptions, column names, column labels, or column descriptions.

20. The one or more non-transitory computer-readable media of claim 16, wherein the searching comprises identifying elements that are likely to identify or disambiguate references to attributes, metrics, and other data objects referenced in the user prompt.
